(19) United States
(12) Patent Application Publication
(10) Pub. No.: US 2011/0162007 A1
(43) Pub. Date: Jun. 30, 2011

(54) TELEVISION SYSTEM PROVIDING USER-INTERACTION RELATED TO AN IN-PROGRESS TELEVISION PROGRAM

(75) Inventors: Jeyhan Karaoguz, Irvine, CA (US); Nambirajan Seshadri, Irvine, CA (US)

(73) Assignee: BROADCOM CORPORATION, Irvine, CA (US)

(21) Appl. No.: 13/046,095

(22) Filed: Mar. 11, 2011

Related U.S. Application Data
(63) Continuation-in-part of application No. 12/880,851, filed on Sep. 13, 2010.
(60) Provisional application No. 61/242,234, filed on Sep. 14, 2009.

(51) Int. Cl. H04N 5/445

(52) U.S. Cl. 725/39

(57) ABSTRACT

A system and method in a television system for providing user-interaction related to an in-progress television program, substantially as shown in and/or described in connection with at least one of the figures, as set forth more completely in the claims.

CROSS-REFERENCE TO RELATED APPLICATIONS/INCORPORATION BY REFERENCE

This patent application is a continuation-in-part of U.S. patent application Ser. No. 12/880,851, filed Sep. 13, 2010; which is related to and claims priority from provisional patent application Ser. No. 61/242,234, filed Sep. 14, 2009; the contents of each of which are hereby incorporated herein by reference in their entirety. This patent application is also related to: U.S. patent application Ser. No. 12/880,530, filed Sep. 13, 2010, titled “SYSTEM AND METHOD IN A DISTRIBUTED SYSTEM FOR RESPONDING TO USER-SELECTION OF AN OBJECT IN A TELEVISION PROGRAM”; U.S. patent application Ser. No. 12/880,594, filed Sep. 13, 2010, titled “SYSTEM AND METHOD IN A LOCAL TELEVISION SYSTEM FOR RESPONDING TO USER-SELECTION OF AN OBJECT IN A TELEVISION PROGRAM”; U.S. patent application Ser. No. 12/880,668, filed Sep. 13, 2010, titled “SYSTEM AND METHOD IN A TELEVISION SYSTEM FOR RESPONDING TO USER-SELECTION OF AN OBJECT IN A TELEVISION PROGRAM BASED ON USER LOCATION”; U.S. patent application Ser. No. 12/881,067, filed Sep. 13, 2010, titled “SYSTEM AND METHOD IN A TELEVISION SYSTEM FOR PRESENTING INFORMATION ASSOCIATED WITH A USER-SELECTED OBJECT IN A TELEVISION PROGRAM”; U.S. patent application Ser. No. 12/881,096, filed Sep. 13, 2010, titled “SYSTEM AND METHOD IN A TELEVISION SYSTEM FOR PRESENTING INFORMATION ASSOCIATED WITH A USER-SELECTED OBJECT IN A TELEVISION PROGRAM”; U.S. patent application Ser. No. 12/880,749, filed Sep. 13, 2010, titled “SYSTEM AND METHOD IN A TELEVISION SYSTEM FOR RESPONDING TO USER-SELECTION OF AN OBJECT IN A TELEVISION PROGRAM UTILIZING AN ALTERNATIVE COMMUNICATION NETWORK”; U.S. patent application Ser. No. 12/880,851, filed Sep. 13, 2010, titled “SYSTEM AND METHOD IN A TELEVISION SYSTEM FOR PROVIDING ADVERTISING INFORMATION ASSOCIATED WITH A USER-SELECTED OBJECT IN A TELEVISION PROGRAM”; U.S. patent application Ser. No. 12/880,888, filed Sep. 13, 2010, titled “SYSTEM AND METHOD IN A TELEVISION FOR PROVIDING ADVERTISING INFORMATION ASSOCIATED WITH A USER-SELECTED OBJECT IN A TELEVISION PROGRAM”; and U.S. patent application Ser. No. 12/881,110, filed Sep. 13, 2010, titled “SYSTEM AND METHOD IN A TELEVISION FOR PROVIDING INFORMATION ASSOCIATED WITH A USER-SELECTED INFORMATION ELEMENT IN A TELEVISION PROGRAM”. The contents of each of the above-mentioned applications are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Present television systems are generally incapable of providing for user-specification of actions related to objects presented in a television program. Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method in a television system for providing user-interaction related to an in-progress television program, substantially as shown in and/or described in connection with at least one of the figures, as set forth more completely in the claims, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a diagram illustrating an exemplary television system, in accordance with various aspects of the present invention.

FIG. 2 is a flow diagram illustrating an exemplary method for providing user-interaction related to an in-progress television program, in accordance with various aspects of the present invention.

FIG. 3 is a flow diagram illustrating an exemplary method for providing user-interaction related to an in-progress television program, in accordance with various aspects of the present invention.

FIG. 4 is a diagram illustrating an exemplary television, in accordance with various aspects of the present invention.

FIG. 5 is a diagram illustrating an exemplary television receiver, in accordance with various aspects of the present invention.

FIG. 6 is a diagram illustrating an exemplary television controller, in accordance with various aspects of the present invention.

FIG. 7 is a diagram illustrating exemplary modules and/or sub-modules for a television system, in accordance with various aspects of the present invention.

### DETAILED DESCRIPTION OF VARIOUS ASPECTS OF THE INVENTION

The following discussion will refer to various communication modules, components or circuits. Such modules, components or circuits may generally comprise hardware and/or a combination of hardware and software (e.g., including firmware). Such modules may also, for example, comprise a computer readable medium (e.g., a non-transitory medium) comprising instructions (e.g., software instructions) that, when executed by a processor, cause the processor to perform various functional aspects of the present invention. Accordingly, the scope of various aspects of the present invention should not be limited by characteristics of particular hardware and/or software implementations of a module, component or circuit unless explicitly claimed as such. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by an application-specific integrated circuit (“ASIC”) and/or other hardware components.

Additionally, the following discussion will refer to various television system modules (e.g., television modules, television receiver modules, television controller modules, modules of a user's local television system, modules of a geographically distributed television system, etc.). It should be noted that the following discussion of such various modules is segmented into such modules for the sake of illustrative clarity. However, in actual implementation, the boundaries between various modules may be blurred. For example, any or all of the functional modules discussed herein may share various hardware and/or software components. For example, any or all of the functional modules discussed herein may be implemented wholly or in-part by a shared processor executing software instructions. Additionally, various software sub-modules that may be executed by one or more processors may be shared between various software modules. Accordingly, the scope of various aspects of the present invention should not be limited by arbitrary boundaries between various hardware and/or software components, unless explicitly claimed.

The following discussion may also refer to communication networks and various aspects thereof. For the following discussion, a communication network is generally the communication infrastructure through which a communication device (e.g., a portable communication device, television, television control device, television provider, television programming provider, television receiver, video recording device, etc.) may communicate with other systems. For example and without limitation, a communication network may comprise a cable and/or satellite television communication network, a cellular communication network, a wireless metropolitan area network (WMAN), a wireless local area network (WLAN), a wireless personal area network (WPAN), any home or premises communication network, etc. A particular communication network may, for example, generally have a corresponding communication protocol according to which a communication device may communicate with the communication network. Unless so claimed, the scope of various aspects of the present invention should not be limited by characteristics of a particular type of communication network.

Additionally, the following discussion will at times refer to television programming. Such television programming generally includes various types of television programming (e.g., television programs, news programs, sports programs, music television, movies, television series programs and/or associated advertisements, educational programs, live or recorded television programming, broadcast/multicast/unicast television programming, etc.). Such television programming may, for example, comprise real-time television broadcast programming (or multicast or unicast television programming) and/or user-stored television programming that is stored in a user device (e.g., a VCR, PVR, etc.). Such television programming video content is to be distinguished from other non-programming video content that may be displayed on a television screen (e.g., an electronic program guide, user interface menu, a television set-up menu, a typical web page, a document, a graphical video game, etc.). Various aspects of the present invention may, for example in a television system, comprise receiving a television program, presenting such received television program to a user, determining one or more objects in the television program for which various actions may be performed, determining based on a user input one or more actions to perform with regard to an object in the television program, and performing such determined one or more actions.

Also, the following discussion will at times refer to objects in television programming. Such objects include both animate (i.e., living) and inanimate (i.e., non-living) objects, both still and moving. Such objects may, for example, comprise characteristics of any of a variety of objects present in television programming. Such objects may, for example and without limitation, comprise inanimate objects, such as consumer good objects (e.g., a general consumer product, clothing, automobiles or other vehicles, shoes, jewelry, furniture, restaurant, food, beverages, appliances, electronics, toys, artwork, cosmetics, recreational vehicles, sports equipment, safety equipment, computer equipment, communication devices, books, home improvement products, medication, etc.), consumer service objects (e.g., objects (e.g., signs, banners, flyers, buildings, vehicles, etc.) related to health services, a fitness center, a rehabilitation center, restaurant services, food services, entertainment services, repair services, insurance services, financial services, security services, transportation services, shopping services, delivery services, education services, communication services, vacation services, rental services, information services, legal services, etc.), premises objects (e.g., business locations, stores, hotels, signs, doors, buildings, landmarks, historical sites, entertainment venues, hospitals, government buildings, etc.), objects related to general services (e.g., objects related to free transportation, objects related to emergency services, objects related to general government services, objects related to free entertainment services, etc.), objects related to location (e.g., parks, landmarks, streets, signs, road signs, etc.), etc. Such objects may, for example, comprise animate objects, such as people (e.g., actors/actresses, athletes, musicians, salespeople, commentators, reports, analysts, hosts/hostesses, entertainers, etc.), animals (e.g., pets, zoo animals, wild animals, etc.) and plants (e.g., flowers, trees, shrubs, fruits, vegetables, cacti, etc.).

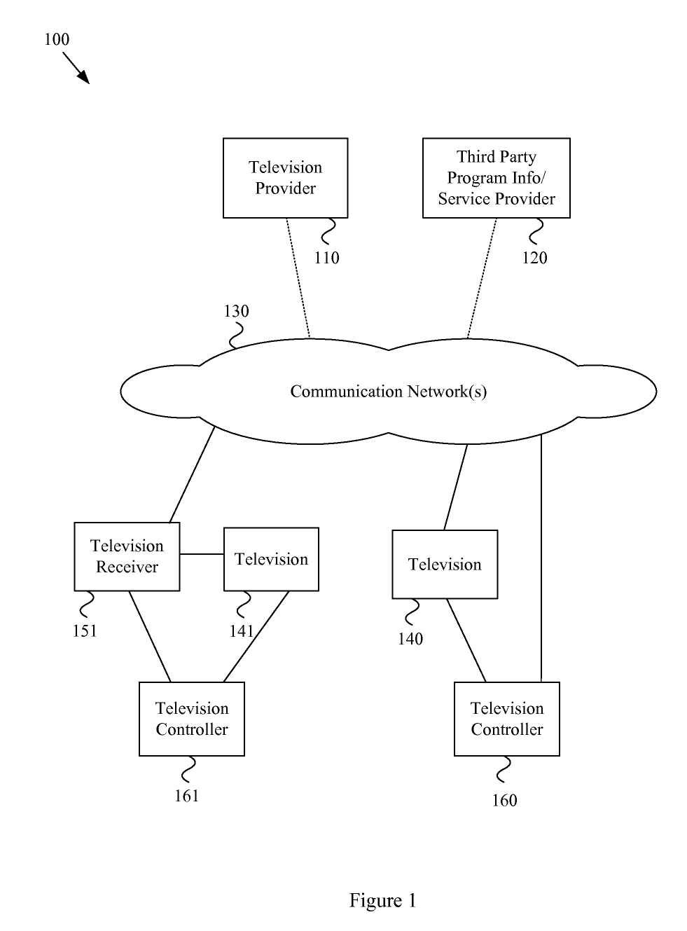

Turning first to FIG. 1, such figure is a diagram illustrating a non-limiting exemplary television system 100 in accordance with various aspects of the present invention. The exemplary system 100 includes a television provider 110. The television provider 110 may, for example, comprise a television network company, a cable company, a movie-providing company, a news company, an educational institution, etc. The television provider 110 may, for example, be an original source of television programming (or related information). Also for example, the television provider 110 may be a communication company that provides programming distribution services (e.g., a cable television company, a satellite television company, a telecommunication company, a data network provider, etc.). The television provider 110 may, for example, provide television programming and non-programming information and/or video content. The television provider 110 may, for example, provide information related to a television program (e.g., information describing or otherwise related to objects in television programming, commerce information related to a consumer good and/or service, etc.). The television provider 110 may, for example, provide any or all of the types of information discussed herein. The television provider 110 may, for example, operate to (which includes “operate when enabled to”) perform any or all of the functionality discussed herein (e.g., working in conjunction with other entities of the exemplary television system 100).

The exemplary television system 100 may also include a third party program information and/or service provider 120. Such a provider may, for example, provide information and/or services related to a television program. Such information may, for example, comprise information describing objects in programming, information to provide to a user upon request for respective information of an object in programming, information related to various actions (e.g., commercial transaction actions, communication actions, etc.) that may be performed (e.g., with networked entities remote from the user's local television system) upon user selection of such an action related to an object in television programming, commerce information related to a consumer good and/or service related to an object in television programming, guide information, etc. The third party program information and/or service provider 120 may, for example, provide any or all of the types of information and/or services discussed herein. The third party program information and/or service provider 120 may, for example, operate to (which includes “operate when enabled to”) perform any or all of the functionality discussed herein (e.g., working in conjunction with other entities of the exemplary television system 100).

In various exemplary system scenarios, the third party program information and/or service provider 120 may, for example, correspond to a source of a consumer good and/or service (e.g., a commercial enterprise, a manufacturer, a supplier, a distributor, a retailer, business, Internet business, brick-and-mortar business, etc.). For example, such third party program information and/or service provider 120 may correspond to a commercial enterprise website. Also for example, such third party program information and/or service provider 120 may correspond to a central repository for information and/or user interaction for a plurality of such commercial enterprises (e.g., a commercial enterprise, a manufacturer, a supplier, a distributor, a retailer, business, consumer good and/or service rating company, a blog service, a consumer advocacy service, etc.).

The exemplary television system 100 may include one or more communication networks (e.g., the communication network(s) 130). The exemplary communication network 130 may comprise characteristics of any of a variety of types of communication networks over which television programming and/or information related to television programming (e.g., information identifying and/or describing and/or otherwise related to objects in television programming), information related to commercial transactions related to objects in television programming, etc., may be communicated. For example and without limitation, the communication network 130 may comprise characteristics of any one or more of: a cable television network, a satellite television network, a telecommunication network, a general data network, the Internet, a local area network (LAN), a personal area network (PAN), a metropolitan area network (MAN), any of a variety of different types of home networks, etc.

The exemplary television system 100 may include a first television 140. Such a first television 140 may, for example, comprise networking capability enabling such television 140 to communicate directly with the communication network 130. For example, the first television 140 may comprise one or more embedded television receivers or transceivers (e.g., a cable television receiver, satellite television transceiver, Internet modem, etc.). Also for example, the first television 140 may comprise one or more recording devices (e.g., for recording and/or playing back video content, television programming, etc.). The first television 140 may, for example, operate to (which includes “operate when enabled to”) perform any or all of the functionality discussed herein. Such functionality may, for example and without limitation, comprise user interface functionality, performing actions related to objects in television programming (e.g., providing information, facilitating commercial transactions, establishing communication links, etc.).

The exemplary television system 100 may include a first television controller 160. Such a first television controller 160 may, for example, operate to (e.g., which includes “operate when enabled to”) control operation of the first television 140. The first television controller 160 may comprise characteristics of any of a variety of television controlling devices. For example and without limitation, the first television controller 160 may comprise characteristics of a dedicated television control device, a universal remote control, a cellular telephone or personal computing device with television control capability, any personal electronic device with television control capability, etc. The first television controller 160 may, for example, operate to (which includes “operate when enabled to”) perform any or all of the functionality discussed herein. In a non-limiting exemplary configuration, the first television controller 160 may comprise an on-board display which may operate as a television screen (e.g., a primary, secondary and/or parallel television screen) via which the first television controller 160 may present television programming and/or interface with a user regarding objects (e.g., objects representative of consumer goods and/or services, people, etc.) in television programming.

The first television controller 160 (or television control device) may, for example, transmit signals directly to the first television 140 to control operation of the first television 140. The first television controller 160 may also, for example, operate to transmit signals (e.g., via the communication network 130) to the television provider 110 to control television programming (or related information) being provided to the first television 140, or to conduct other transactions (e.g., business transactions, general communication transactions, etc.).

As will be discussed in more detail later, the first television controller 160 may operate to communicate user interface information with the first television 140 and/or other devices. Also, as will be discussed in more detail later, various aspects of the present invention include a user selecting a user-selectable object in programming and/or a user-selectable action associated with such an object. Such selection may, for example, be performed by the user pointing to a location on a television screen (e.g., pointing to an animate or inanimate object presented in television programming), utilizing cursor movement and/or list/menu traversal capability, etc. In an exemplary scenario, the user may perform such pointing, cursor movement and/or list/menu traversal in any of a variety of manners. Some of such exemplary manners include pointing with a television control device and/or utilizing other movement features provided with such a television control device. The first television controller 160 provides a non-limiting example of a device that a user may utilize to perform such user interface operations.

As will be mentioned throughout the following discussion, various aspects of the invention will be performed by one or more devices, components and/or modules of a user's local television system. The first television 140 and first television controller 160 provide a non-limiting example of a user's local television system. Such a user's local television system, for example, generally refers to the television-related devices that are local to the television system currently being utilized by the user. For example, when a user is utilizing a television system located at the user's home, the user's local television system generally refers to the television-related devices that make up the user's home television system. Also for example, when a user is utilizing a television system at a premises away from the user's home (e.g., at another home, at a hotel, at an office, etc.), the user's local television system generally refers to the television-related devices that make up the premises television system Such a user's local television system does not, for example, comprise television network infrastructure devices that are generally outside of the user's current premises (e.g., cable and/or satellite head-end apparatus, cable and/or satellite communication intermediate communication network nodes), devices generally associated with commercial enterprises outside of the user's current premises, and/or programming source devices that are generally managed by television enterprises and generally exist outside of the user's home. Such entities, which may be communicatively coupled to the user's local television system, may be considered to be entities remote from the user's local television system (or “remote entities”).

The exemplary television system 100 may also include a television receiver 151. The television receiver 151 may, for example, operate to (e.g., which includes “operate when enabled to”) provide a communication link between a television and/or television controller and a communication network and/or information/service provider. For example, the television receiver 151 may operate to provide a communication link between the second television 141 and the communication network 130, or between the second television 141 and the television provider 110 (and/or third party program information and/or service provider 120) via the communication network 130.

The television receiver 151 may comprise characteristics of any of a variety of types of television receivers. For example and without limitation, the television receiver 151 may comprise characteristics of a cable television receiver, a satellite television receiver, etc. Also for example, the television receiver 151 may comprise a data communication network modem for data network communications (e.g., with the Internet, a LAN, PAN, MAN, telecommunication network, etc.). The television receiver 151 may also, for example, comprise recording capability (e.g., programming recording and playback, etc.). The television receiver 151 may, for example, be a stand-alone component (e.g., a set top box) or may be integrated with any of a variety of other television system components (e.g., a television, a video recorder, a gaming station, etc.). The television receiver 151 may, for example, operate to (which includes “operate when enabled to”) perform any or all of the functionality discussed herein.

The exemplary television system 100 may include a second television controller 161. Such a second television controller 161 may, for example, operate to (e.g., which includes “operate when enabled to”) control operation of the second television 141 and the television receiver 151. The second television controller 161 may comprise characteristics of any of a variety of television controlling devices. For example and without limitation, the second television controller 161 may comprise characteristics of a dedicated television control device, a dedicated television receiver control device, a universal remote control, a cellular telephone or personal computing device with television control capability, any personal electronic device with television control capability, etc.

The second television controller 161 may, for example, operate to transmit signals directly to the second television 141 to control operation of the second television 141. The second television controller 161 may, for example, operate to transmit signals directly to the television receiver 151 to control operation of the television receiver 151. The second television controller 161 may additionally, for example, operate to transmit signals (e.g., via the television receiver 151 and the communication network 130) to the television provider 110 to control television programming (or related information) being provided to the television receiver 151, or to conduct other transactions (e.g., business transactions, etc.). The second television controller 161 may further, for example, operate to receive signals from the second television 141 and/or television receiver 151. Such signals may, for example, comprise signals communicating television programming, information identifying and/or describing user-selectable objects in television programming and/or associated actions and/or any of a variety of other information to the second television controller 161. As a non-limiting example, the second television controller 161 may comprise an on-board display which may operate as a television (e.g., a primary television, secondary television, parallel television (presenting on the on-board display a same television program as that being presented by the second television 141), etc.). In such a configuration, the second television controller 161 may, for example, operate to perform any or all of the functionality discussed herein.

As will be discussed in more detail later, various aspects of the present invention include a user selecting a user-selectable object (e.g., an object associated with a consumer good and/or service) in programming and/or a user-selectable action associated with such an object. Such selection may, for example, comprise the user pointing to a location on a television screen (e.g., pointing to an animate or inanimate object presented in television programming), utilizing cursor movement and/or list/menu traversal capability, etc. In such a scenario, the user may perform such pointing, cursor movement and/or list/menu traversal in any of a variety of manners. Some of such exemplary manners include pointing with a television control device and/or utilizing other movement features provided with such a television control device. The second television controller 161 provides one non-limiting example of a device that a user may utilize to point to an on-screen location. Also, in a scenario in which the second television controller 161 comprises a touch screen, a user may touch a location of such touch screen to perform such user interface operations.

As will be mentioned throughout the following discussion, and as mentioned previously in the discussion of the first television 140 and television controller 160, various aspects of the invention will be performed by one or more devices, components and/or modules of a user's local television system. The second television 141, television receiver 151 and second television controller 161 provide another non-limiting example of a user's local television system.

The exemplary television system 100 was provided to provide a non-limiting illustrative foundation for discussion of various aspects of the present invention. Thus, the scope of various aspects of the present invention should not be limited by any characteristics of the exemplary television system 100 unless explicitly claimed.

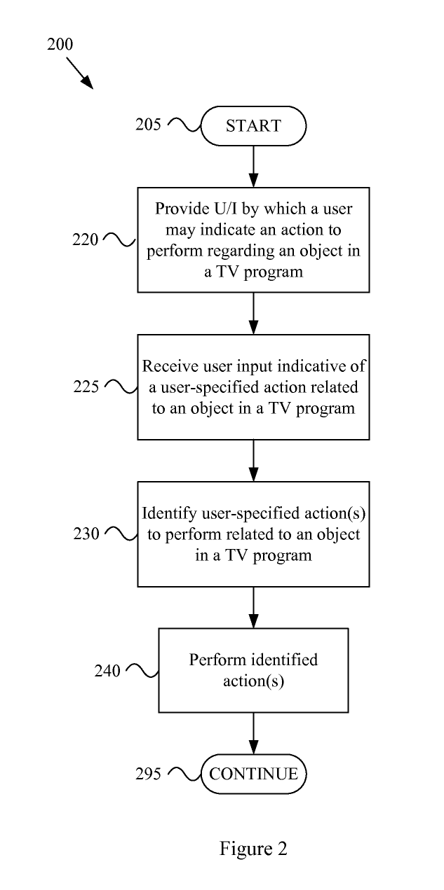

FIG. 2 is a flow diagram illustrating an exemplary method 200 for providing user-interaction related to an in-progress television program (e.g., related to objects therein), in accordance with various aspects of the present invention. Any or all aspects of the exemplary method 200 may, for example, be implemented in one or more devices (or components or modules) of a user's local television system (e.g., in any one or more of the first television 140 and/or second television 141, the television receiver 151, the first television controller 160 and/or second television controller 161, etc., shown in FIG. 1 and discussed previously). Also for example, various aspects may also be performed in one or more system entities remote from the user's local television system (e.g., by a third party program information and/or service provider 120, by a television programming provider 110, by infrastructure components of a communication network 130, etc.).

The following discussion will at times refer to various actions that may be performed related to an object in a television program being presented to a user (e.g., presented at a normal play rate, at a reduced rate, in a paused state, etc.). Various non-limiting exemplary characteristics of such objects in a television program were provided above. Such actions related to an object in a television program may comprise various characteristics, non-limiting examples of which will now be provided.

For example and without limitation, exemplary actions may comprise actions related to acquiring and/or presenting to a user information related to one or more objects in the television program. Such information may, for example, comprise general information concerning particular objects and/or events depicted in the television program. For example, such information may comprise general information regarding information about one or more teams playing in a sporting event shown in the television program (e.g., team identity, team standings and/or statistics, etc.). Also for example, such information may comprise general information about a musical group and/or other entertainment organization associated with the television program. Additionally for example, such information may comprise general information about a news organization associated with a report being presented in a television program. Further for example, such information may comprise general information about a political party associated with a television program or portion thereof. Still further for example, such information may comprise general information about an environmental organization associated with a television program.

Also for example, such information may comprise specific information regarding specific objects in the television program. As mentioned above, such objects may comprise animate objects (e.g., characters, actors, musicians, entertainers, athletes, coaches, officials, politicians, reporters, animals, commentators, analysts, etc.). In an exemplary scenario concerning an animate object, such object-specific information may comprise information specifically associated with such an animate object. For example, for an actor object, such object-specific information may comprise actor background information, filmography information, personal information, fan club information, personal web site information, social network site information, etc. Additionally for example, for a politician object, such object-specific information may comprise party affiliation information, voting history information, information describing the politician's stances on particular issues, contact information, etc. Further for example, in an exemplary scenario in which a person (or organization) object is a subject of a news report, such object-specific information may comprise information regarding such person (or organization). Still further for example, for an athlete object, such object-specific information may comprise sports statistics for the athlete, contact information for the athlete and/or associated team, information regarding obtaining merchandise associated with the athlete and/or associated team, information regarding the athlete's personal and/or professional history, information regarding obtaining tickets to watch the athlete and/or the athlete's team perform, contract information, sponsorship information, agent information, manager information, etc.

Also as mentioned above, such objects may comprise inanimate objects (e.g., consumer goods, buildings, landmarks, venues, parks, machines, signs, vehicles, clothing, food, etc.). In such a scenario, such object-specific information may comprise information specifically associated with such inanimate object. For example, in an exemplary scenario involving a landmark object, park object, museum object, club object, etc., such object-specific information may comprise address and/or direction information, hours of operation, contact information, admission rates, reservation information, and/or other visiting information. In another exemplary scenario involving an object of historical significance (e.g., a famous landmark, a historical building or site, etc.), such object-specific information may comprise historical information for such object, visiting information for such object, merchandizing information for such object, etc. In yet another exemplary scenario involving a consumer good object in a television program, the object-specific information may comprise information describing such consumer good, information indicating a source of such consumer good, information describing the manner in which a person may obtain such consumer good, price information of such consumer good, etc.). In still another exemplary scenario involving a consumer service object (e.g., a building, sign, vehicle, uniform, logo, etc., associated with a consumer service), the object-specific information may comprise information describing such consumer service, information indicating a source of such consumer service, information indicating pricing and/or availability of such consumer service, information describing the manner in which a person may obtain such consumer service, etc.).

Note that object-specific information may, in various exemplary scenarios, be intermixed with general information about the television program (e.g., information that is not specifically related to particular objects shown in the television program). For example, such general information may comprise information regarding a television program producer, information regarding a television program sponsor, information about a television program broadcasting company, information about a television program content provider, information describing the television program, etc.).

Other non-limiting exemplary actions related to an object in a television program may comprise actions related to performing a commercial transaction related to an object in the television program. Various non-limiting examples of such commercial transaction actions will now be provided.

For example, such commercial transaction actions may comprise ordering a product (or consumer good) associated with an object in the television program. In an exemplary scenario involving a consumer good object, such actions may comprise ordering (or purchasing) the consumer good. In an exemplary scenario involving an object associated with a producer and/or supplier of a commercial good (e.g., a building object, sign object, trademark logo, representative, delivery truck object, etc.), such actions may comprise interacting with such producer and/or supplier to purchase the consumer good. In another exemplary scenario involving a tourist-related object (e.g., a landmark, venue, park, etc.), such actions may comprise interacting with an organization associated with such tourist-related object to purchase souvenirs, purchase tickets, make reservations, etc. In yet another exemplary scenario involving a player object and/or team object in a television program showing a sports event, such actions may comprise ordering player and/or team merchandise. In an exemplary scenario involving a musician and/or band object shown in a television program, such actions may provide ordering music provided by such musician and/or band.

Also for example, such commercial transaction actions may comprise ordering (or purchasing) a service associated with an object in the television program. Such services may, for example and without limitation, comprise moving services, delivery services, shipping services, transportation services, lodging services, legal services, entertainment services, food services, etc. For example, in an exemplary scenario involving a player and/or team object in a television program showing a sports event, such actions may comprise ordering tickets for the sports event and/or a future sports event involving the same player, team and/or venue. Also for example, in an exemplary scenario involving a hotel object shown in a television program, such actions may comprise making reservations at the hotel. Further for example, in an exemplary scenario involving a transportation object (e.g., an airplane, train, bus, etc.), such actions may comprise purchasing and/or reserving transportation services.

Additionally for example, such actions may comprise determining product and/or service availability. For example, in an exemplary scenario in which an object in a television program corresponds to a consumer good, such actions may comprise searching for sources of such a consumer good and providing product availability information (e.g., sources, prices, delivery times, etc.) to the user (e.g., on a television screen, on a personal computing device communicatively coupled to the television system, via email, etc.). Also for example, such actions may further comprise searching for one or more preferred sources for such consumer good (e.g., based on user-defined prioritization criteria, such as lowest price, fastest delivery time, closest source, etc.).

Further for example, such actions may comprise searching for review (or rating) information. For example, in an exemplary scenario involving an object in a television program that is associated with a consumer good and/or service, such actions may comprise searching various consumer good and/or service rating databases for review information, which may then be provided to the user (e.g., on a television screen, on a personal computing device communicatively coupled to the television system, via email, etc.).

Other non-limiting exemplary actions related to an object in a television program may comprise actions related to performing communication (e.g., network communication) related to an object in the television program. Various non-limiting examples of such communication actions will now be provided.

For example, such communication actions may comprise performing commercial transaction communication. For example, such actions may comprise initiating a communication with an entity (e.g., a commercial enterprise) associated with an object in the presented television program. For example, such actions may comprise establishing a communication session (e.g., via a data network, via a telephone network, via a television network, etc.) with a supplier of a consumer good and/or service associated with the object. In such an exemplary scenario, such actions may comprise establishing a communication session with an Internet web site associated with the object and/or a person.

Also for example, such communication actions may comprise establishing a communication session with one or more networked information databases comprising information for one or both of a consumer good and/or service associated with the object. Such information databases may, for example, comprise consumer good and/or service review websites, websites of commercial enterprises producing and/or supplying a consumer good and/or service associated with the object, government regulatory websites associated with a particular consumer good and/or service, websites of consumer protection groups, etc.

Additionally for example, such communication actions may comprise establishing a communication session with a website and/or social networking site associated with a person corresponding to the object. For example, such actions may comprise establishing an Internet connection with an actor's social networking site, a musician's website, a team's website, a venue's ticket broker, etc.

Further for example, such communication actions may also comprise establishing a communication session with a person and/or automated system associated with an entertainer in a television program, a television program source, a television program sponsor, a television distribution network provider, etc.

Such communication actions may, for example, comprise performing one-way (e.g., email, posting, etc.) and/or two-way (e.g., live chat, voice call, video call, etc.) communications. Also, such communication actions may, for example, comprise performing communication over any of a variety of media (e.g., wired and/or wireless media, tether and/or non-tethered optical media, etc.). As mentioned above, such communication actions may comprise communicating with a person (e.g., entertainers, technical support personnel, ordering support personnel, general customer support personnel, etc.) and/or communicating with an automated system.

The above-mentioned exemplary actions, which may be associated with objects in a television program, are merely exemplary and non-limiting. Accordingly, the scope of various aspects of the present invention should not be limited by characteristics of such exemplary actions unless explicitly claimed.

As will be discussed below, various actions associated with objects in a television program might be available throughout the entire television program, but might also be available only during a portion of the television program. Additionally, actions associated with different respective objects in a television program might be available during different respective portions of the television program (e.g., where such different respective portions may be the same, distinctly different, or partially overlapping).

For example, one or more actions may be available to perform related to an object in a television program being presented only when the object appears in the presented television program. As a non-limiting example, an action comprising obtaining information for an actor might only be available during scenes in which the actor is present. Also for example, an action comprising providing descriptive information for a consumer good object in the television program might be available only when the object is presently being shown in the television program. Additionally for example, an action related to an athlete participating in a sporting event might only be available when such athlete is performing and/or on-screen.

Additionally for example, an action associated with a consumer good and/or service object in the television program might be available only during a portion (e.g., a time window, a fractional segment, etc.) of the television program that is sponsored by a commercial enterprise (e.g., a producer, a retailer or other source, an importer, etc.) associated with the object. For example, in an exemplary scenario in which a commercial enterprise has sponsored the first half of a television program, actions related to particular objects of concern for the commercial enterprise might only be made available during such first half.

In another exemplary scenario, one or more actions associated with a consumer good and/or service object depicted in a television program commercial might only be made available during presentation of the television program commercial. Such availability might, for example, be strict (e.g., strictly only during presentation of the television program commercial with no exceptions) or general (e.g., during presentation of the television program commercial but possibly also during a relatively small time buffer surrounding the television program commercial, leaving at least some degree of flexibility). In such a scenario, available actions might be limited to actions generally associated with the television program commercial during presentation of such commercial, and actions related to objects appearing in the non-commercial portion of the television program might not be available during presentation of the television program commercial. For example, an action comprising providing information regarding an actor in a television program might not be available during presentation of a sponsored television commercial.

As mentioned above, some actions might be available only during a portion of a television program while other actions related to objects in the television program might be available throughout the entire duration of the television program. Also for example, an action related to an organization (e.g., a sports team, a television network, a movie company, a producer, etc.) associated with the television program might be available for the entire duration of the television program.

As discussed above, some actions might be available only during a portion of the television program, while others might be available during the entire duration of the television program. Accordingly, the scope of various aspects of the present invention should be limited by characteristics of such action availability unless explicitly claimed.

The exemplary method 200 may, for example, begin executing at step 205. The exemplary method 200 may begin executing in response to any of a variety of causes and/or conditions, non-limiting examples of which will now be provided. For example, the exemplary method 200 may begin executing in response to a user command to begin, in response to any user input indicative of the user desiring to perform an action with regard to the television programming currently being presented and/or an object shown therein (e.g., an object associated with a consumer good and/or service) in a television program, upon television and/or television receiver and/or television controller reset or power-up, in response to a user input indicating a desire to provide object and/or action selection capability to the user, in response to identification of a user and/or user equipment for which object and/or action selection capability is to be provided, in response to receipt and/or presentation of a television program comprising user-selectable objects and/or actions, in response to user payment of a fee, etc.

In a non-limiting exemplary scenario in which execution of the method 200 is caused by a user input, such user input may, for example, comprise a pushbutton on a remote control, a button touched or pressed on a personal electronic device that is communicatively coupled to a television system, a user touching a particular location on a display, the user touching any location on a display (e.g., of a television, television receiver, television controller, etc.), etc.

The exemplary method 200 may, for example at step 220, comprise providing a user interface by which a user may indicate an action to perform related to an object in the presented television program. Step 220 may comprise providing such a user interface in any of a variety of manners, non-limiting examples of which will now be provided. Such a user interface may for example, comprise a graphical user interface (GUI) presented to the user on a display (e.g., a television display, a television receiver display, a television controller display, a display of a personal computing device, etc.). Note that step 220 may comprise presenting such a user interface on the same display on which the television program is being presented or on a different display (e.g., on a display of a television control device, while the television program is being presented on a display of the television).

Step 220 may, for example, comprise presenting the user with a list of objects in the television program and/or associated actions from which the user may select. Such a presented list of objects and/or actions may, for example, be nested. For example, step 220 may first comprise presenting a user with a list of objects in the television program from which the user may select an object of interest. In response to such a selection, step 220 may then comprise presenting the user with a list of available actions that may be performed related to the user-selected object. Similarly, lists of objects and/or actions may themselves be nested. Using such a user interface, a user may navigate through the list(s) to select a desired action to perform.

Also for example, step 220 may comprise presenting such a list of objects and respective corresponding actions on a single screen (e.g., in a matrix format). Additionally for example, step 220 may comprise presenting such a list of objects and/or respective actions in a GUI menu structure.

The user interface presented at step 220 may comprise presenting a list comprising any of the object and/or action information discussed above. For example and without limitation, in a scenario comprising a communication action related to objects in a television program, step 220 may comprise presenting to the user a list of entities with which a communication session may be established related to respective object(s) in the television program. Step 220 may, for example, comprise presenting information of any of the communication options discussed above. The user may then, for example, select a desired communication action to perform. Step 220 may also, for example, comprise presenting communication options generally related to the television program and/or generally related to an organization associated with the television program (e.g., a sponsor, ticket provider, a charitable organization, a producer, a team, a league, etc.) from which the user may select.

Also for example, in a scenario comprising providing information related to objects in a television program, step 220 may comprise presenting the user with a list of types of information available related to respective object(s) in the television program. Additionally, step 220 may comprise presenting the user with a list of types of information that are available for particular organizations and/or enterprises associated with the television program. Step 220 may, for example, comprise presenting information of any of the information-providing options discussed above. The user may then, for example, select desired information to be presented to the user. Step 220 may also, for example, comprise presenting information-providing options generally related to the television program and/or generally related to an organization associated with the television program (e.g., a sponsor, ticket provider, a charitable organization, a producer, a team, a league, etc.) from which the user may select.

Further for example, in a scenario comprising performing commercial transactions, step 220 may comprise presenting the user with a list of commercial transaction-related actions that are available to perform related to respective object(s) in the television program. Step 220 may, for example, comprise presenting information of any of the commercial transaction options discussed above. The user may then, for example, select a desired commercial transaction to be performed. Step 220 may also, for example, comprise presenting commercial transaction options generally related to the television program and/or generally related to an organization associated with the television program (e.g., a sponsor, ticket provider, a charitable organization, a producer, a team, a league, etc.) from which the user may select.

The user interface may provide for user interaction therewith in any of a variety of manners. For example, a user may interact with the user interface utilizing a dedicated television controller, a personal electronic device with the capability (e.g., necessary software applications and/or hardware) to interact with such a user interface, etc. A user may, for example, interact with such a user interface utilizing a touch screen of the television and/or another display different from the primary television display (e.g., a touch screen of a television controller or other personal electronic device, a touch screen of a secondary display, a touch screen of a laptop or notebook computer, etc. Also for example, a user may interact with such a user interface using a pointing device (e.g., a directional beam, light pen, etc.) and/or various movement-control features of a user interface device (e.g., a mouser, trackball, arrow buttons, etc.).

As discussed above, particular actions related to an object in a television program might be available only during a portion of the television program (e.g., only when the object appears in the presented television program, only during portions of the television program sponsored by a commercial enterprise associated with the object, etc.). In such a scenario, step 220 may, for example, comprise presenting such objects and/or related actions for user selection only when such actions are available. Alternatively for example, step 220 may comprise highlighting objects and/or related actions that are presently available, while still showing (e.g., in a muted, grayed out, de-emphasized manner, etc.) objects and/or related actions that are not presently available, but which might be at some point in the future.

Also, as mentioned above, particular actions might be available during the entire television program. In such case, step 220 may comprise providing for user selection of such actions via the user interface throughout the entirety of the television program.

Note, as discussed with regard to step 205, step 220 may comprise presenting the user interface in response to a user input indicating a user's desire to interact regarding objects in the television program and/or respective actions related to such objects. Such a user input may, for example, comprise pushing a controller button dedicated to initiating such interaction. Such a user input may also, for example, comprise receiving a user input via a menu structure via which a user may navigate to select initiation of such user interaction. Such a user input may comprise any of a variety of characteristics (e.g., touching a display, voice command, motion-based command, etc.).

In general, step 220 may comprise providing a user interface by which a user may indicate an action to perform related to an object in the presented television program. Various non-limiting aspects of such U/I providing were presented above. Accordingly, the scope of various aspects of the present invention should not be limited by characteristics of any of the previously presented examples unless explicitly claimed.

The exemplary method 200 may, for example at step 225, comprise receiving (e.g., using the user interface provided at step 220), a user input indicative of a user-specified action to perform related to an object in the presented television program. Step 225 may comprise receiving such user input in any of a variety of manners, non-limiting examples of which will now be provided.

For example, step 225 may comprise receiving a user input selection of a list and/or menu item that is presented to the user on a display (e.g., a display of a television, a display of a television receiver, a display of a television controller, a display of a personal computing device, etc.). Such an input selection may comprise any of a variety of characteristics. For example and without limitation, receiving such a user input selection may comprise receiving a user input pointing to a location on a display that corresponds to a list item, menu item and/or graphical item presented to the user for selection. Also for example, receiving such a user input selection may comprise receiving a user input traversing a list or menu (e.g., utilizing various movement specification mechanisms, like up/down arrows, next buttons, a trackball, a mouse, etc.) and selecting a desired item. Additionally for example, receiving such a user input selection may comprise receiving a user input toggling between graphical items representative of objects in the television program and/or actions associated therewith, and ultimately selecting the desired object and/or action. Further for example, receiving such a user input may comprise receiving a touch screen input from the user touching a desired list item, menu item and/or graphical item. Still further for example, receiving such a user input may comprise receiving an audio input from the user utilizing voice commands to traverse alternative items and ultimately select a desired item.

In general, step 225 may comprise receiving (e.g., using the user interface provided at step 220), a user input indicative of a user-specified action to perform related to an object in the television program. Accordingly, the scope of various aspects of the present invention should not be limited by characteristics of any particular manner of receiving such user input unless explicitly claimed.

The exemplary method 200 may, at step 230, comprise identifying (e.g., based at least in part on the user input received at step 225) an action to perform related to an object in the television program. Step 230 may comprise performing such identification in any of a variety of manners, non-limiting examples of which will now be presented.

For example and without limitation, the user interface presented at step 220 may present user input items (e.g., list items, menu items, graphical items, etc.) that have a one-to-one relationship with an action to perform with regard to an object. In such an implementation, step 230 may merely comprise mapping the user input to the action corresponding to the user input.

Also for example, in another exemplary scenario, the user interface provided at step 220 may comprise providing for a user input selecting a particular object in the television program and another user input selecting a particular action to perform related to such selected object. In such an exemplary scenario, step 230 may comprise combining information of the user-selected object and information of the user-selected action to define the action to perform.

Additionally for example, step 230 may comprise verifying that an action previously known to be available for performing is still available. In such a scenario, for example in which an action is no longer available, the user interface may be updated and execution flow may return to step 220 for further user interaction (e.g., notifying the user that the user-specified action is no longer available and soliciting another input from the user).

In general, step 230 may comprise identifying (e.g., based at least in part on the user input received at step 225) an action to perform related to an object in the television program. Accordingly, the scope of various aspects of the present invention should not be limited by characteristics of any particular manner of identifying such an action to perform unless explicitly claimed.

The exemplary method 200 may, at step 240, comprise performing the identified action (e.g., the action identified at step 230). Step 240 may comprise performing the identified action in any of a variety of manners, non-limiting examples of which will now be provided.

For example, in an exemplary scenario comprising obtaining and/or presenting information to the user related to an object in the presented television program, step 240 may comprise obtaining such information in any of a variety of manners. For example, step 240 may comprise searching local memory for such information (e.g., in an exemplary scenario in which information of objects in a television program are downloaded into the local system prior to a user expressing a desire for such information and/or prior to presentation of the television program). Also for example, step 240 may comprise requesting the desired information from one or more remote systems (e.g., via a communication network). In such a scenario, step 240 may comprise establishing the necessary communication link(s) to perform such requesting and for receiving return information responsive to such requesting. As mentioned above, such sources for object information may comprise information sources associated with consumer good and/or service sources, information sources associated with particular people and/or groups thereof, information sources associated with event venues, etc.

In such a scenario, step 240 may then comprise providing the obtained information to the user. Such providing may, for example, be performed on the same display as that on which the television program is being presented (e.g., in an overlaid and/or blended manner, instead of the television program, etc.) and/or on a different display (e.g., a display of a television controller and/or personal computing device).

Also for example, in an exemplary scenario comprising conducting a commercial transaction related to an object in the presented television program, step 240 may comprise establishing the necessary communication links between the television system (or any component thereof) and a commercial entity with which such commercial transaction will be made. For example, step 240 may comprise retrieving network address and protocol information associated with a commercial enterprise associated with a user-selected commercial transaction, and then utilizing such address and/or protocol information to initiate communication with a target commercial enterprise system. Step 240 may further comprise utilizing the user interface to interact with the user regarding the user-requested commercial transaction (e.g., to obtain shipping information, financial information, etc.).

Additionally for example, in an exemplary scenario comprising initiating a communication with an entity related to an object in the presented television program, step 240 may comprise initiating the desired communication. For example, step 240 may comprise retrieving network address and protocol information associated with a user-selected action, and then utilizing such address and/or protocol information to initiate communication with a target destination system.

Note that in various exemplary scenarios (e.g., those described above), step 240 may comprise soliciting additional information from a user. Such information may, for example, comprise user input information to additionally define the information presented to the user, shipping address information, financial information, contact information, security information, etc.

Step 240 may comprise performing the identified action(s) in any of a variety of manners. For example and without limitation, a user-selected object and/or action may be mapped to a particular software routine that step 240 executes upon identification of a user-specified action at step 230. In an exemplary implementation, the user interface presented at step 220 may comprise logical links to software routines, so that when a user specifies a particular action to perform related to an object in the television program, step 240 comprises executing the linked-to software routine(s). Such software routines may, for example, comprise web browser applications, email and/or social networking applications, specific interface applications associated with particular actions (e.g., provided by commercial enterprises associated with such actions), etc.

In such a software implementation, step 240 may comprise utilizing software routines that always reside on a local television system implementing the method 200. Also, such software routines may be communicated to a system implementing the method 200 along with television program information. In such a scenario, the system may store the relevant software routines during presentation of the television program (in case requested by the user) and then discard such routines after presentation of the television program has been completed. In such a manner, for example, a commercial enterprise that provides a consumer good object in the television program may provide a software routine to be provided to the system implementing the method 200 (e.g., in advance of and/or along with the television program) to be executed by such system in response to a user expressing a desire to perform a commercial transaction related to the consumer good object.

Also, in such a software implementation, the routines may reside remotely at a central location (e.g., a location of the television provider). In such a scenario, step 240 may comprise requesting execution of an identified remote routine upon user selection of a particular action.

In another exemplary implementation, step 240 may comprise providing information of an identified user-specified action (or user input) to a central location (e.g., a television program provider), where one or more servers at such central location perform the user-specified action (e.g., remotely interfacing with the user located at the user's local television system).

Note that during performance of an identified action, step 240 may comprise pausing presentation of the television program. Alternatively, step 240 may comprise performing the identified action while the presentation of the television program proceeds in a normal fashion.

In general, step 240 may comprise performing the identified action(s) related to an object in a television program. Accordingly, the scope of various aspects of the present invention should not be limited by characteristics of any particular manner of performing such action(s) unless explicitly claimed.

The exemplary method 200 may, at step 295, comprise performing continued operation. Such continued operation may comprise characteristics of any of a variety of different types of continued operation, non-limiting examples of which will be presented below.

For example, step 295 may comprise looping execution flow of the exemplary method 200 back to step 220 for continued user interaction, action identification, and action performing. Also for example, step 295 may comprise performing additional user interaction with the user to further refine the user-selected actions identified at step 230 and/or performed at step 240. For example, step 295 may comprise interfacing with a user to determine which actions to perform and/or how such actions should be performed. Additionally for example, upon completion of the one or more actions performed at step 240 (e.g., in a scenario in which television program presentation is paused during the performance of such actions) step 295 may comprise resuming normal presentation of the television program.

Also for example, step 295 may comprise determining when the action(s) being performed at step 240 is complete. Step 295 may, for example, comprise making such a determination in any of a variety of manners. For example and without limitation, step 295 may comprise determining that the action performance is complete based, at least in part, on explicit user command indicating that the user no longer desires to perform such action. Also for example, step 295 may comprise determining that the action performance is complete based, at least in part, on user dismissal of presented information associated with a user-selected action (e.g., closing an information window and/or other GUI mechanism associated with the user-selected action). Additionally for example, step 295 may comprise determining that the action performance is complete based, at least in part, on a timer (e.g., making such determination a predetermined amount of time after an information and/or a GUI interface is presented to a user, after a user has last interacted with the system regarding a user-selected object, etc.). Further for example, step 295 may comprise determining that the action performance is complete based on a user command to perform some other action (e.g., a user command for normal television program play to resume (if halted), a user command for television program play at fast-forward until caught up to real-time, a user command to jump presentation of the television program to real-time, etc.). Still further for example, step 295 may comprise determining that the action performance is complete upon receipt of a message from a remote server (e.g., associated with a commercial enterprise involved in a commercial transaction) that the action has been completed.

In general, step 295 may comprise performing continued operation. Accordingly, the scope of various aspects of the present invention should not be limited by characteristics of any particular type of continued operation unless explicitly claimed.

Various aspects of the present invention will now be presented by way of non-limiting exemplary scenarios.

In a first exemplary scenario, a user may be viewing a hockey match (or other sporting event). The user (e.g., at step 220) pushes a button associated with a desire to perform an action related to the television program (e.g., the hockey match). The system detects the user input and in response provides a list of information and/or other actions related to various objects shown in the hockey match that are available to the user. The list includes an entry associated with team statistics, team schedule, ticket ordering, and a list of individual players on the ice at the particular point in the television program (note that such list may be updated in real-time, for example, as the television program presentation progresses) and types of information available for such players. The user selects a list entry associated with viewing statistics for the team's goalie. The system receives such user input (e.g., at step 225), and identifies the action desired by the user (e.g., at step 230). The system them presents the goalie's stats on the television display superimposed on the hockey match (e.g., until the user acts to dismiss such information).

In a second exemplary scenario, a user may be watching a movie. The user pushes a button associated with a desire to perform an action related to the television program (e.g., the movie). The system detects the user input and in response (e.g., at step 220) provides a list of information available to the user regarding the movie. The list includes an entry associated with director information, producer information, respective information associated with a plurality of selected actors/actresses, information associated with a landmark at which the particular scene of the movie was shot, etc. Note that such list may be updated in real-time, for example, scene-based updating, frame-based updating, sliding time-window based updating, etc. Also note that presentation of the list and/or subsequent user interaction may cause the television program to be paused.

The user selects a list entry associated with a particular actor. In response, the system presents a list of different types of information and/or other actions associated with the selected actor on the display (e.g., until the user acts to dismiss such information). The list includes personal information, filmography, awards, associated charitable causes, fan club information, list of social networking sites associated with the actor, etc. The user (e.g., at step 225) selects the list item associated with one of the actor's social networking (e.g., Facebook™) pages. The system then (e.g., at step 240) establishes a web session at the social networking page for the actor and continues to interact with the user in a manner generally associated with such a web session.

The user then indicates that the user desires to perform a different action. In response (e.g., back at step 220), the system presents the actor's list to the user once again. This time, the user selects the list entry associated with the actor's filmography. The system then (e.g., at step 240) presents on the display, a list of the actor's films and/or related awards. The user then indicates that the user's interaction is complete. In response, the system (e.g., at step 295) returns to presentation of the movie (e.g., in real-time and/or from a paused location). For example, the portion of the movie that occurred during the user interaction may have been recorded for resumption of movie presentation at the point of interruption.

In a third exemplary scenario, a user watches a movie. The user selects a menu item associated with a desire to perform an action related to the television program (e.g., the movie). The system detects the user input and in response (e.g., at step 220) provides a list of information available to the user. The list includes respective entries associated with a plurality of consumer goods in the scene of the movie currently being presented. The user (e.g., at step 225) selects a list entry associated with a particular consumer good. In response (e.g., at step 240), the system presents an information page describing the selected consumer good and providing Internet links at which the user may order the consumer good on-line. The user selects one of the Internet links. The system then presents a user interface associated with the selected Internet link (e.g., a general web browser, a specific user interface provided by the Internet site, etc.). The system then provides the communication link between the user and the commercial enterprise to effect an order of the selected consumer good. The user then indicates that the interaction is complete, and normal presentation of the movie resumes (e.g., at step 295) if such normal presentation was interrupted.

In a fourth exemplary scenario, a user watches a sporting event. The user depresses a button on a television controller associated with a desire to perform an action related to the sporting event television program. For example, such action may comprise a desire to view respective information for all players presently participating in the game (e.g., all players on the field, all players on-court, all players on-ice, etc.). In response to such user input, step 220 provides such information to the user and also provides the user with the capability to perform other actions (e.g., with regard to the players, the teams, the venue, etc.). In providing such information to the user, step 220 may, for example comprise overlaying player names and/or other player information on the players shown on-screen.

The exemplary method 200 may be performed in any one or more components (or devices) of a user's local television system. For example, the method 200 (or a portion thereof) may be performed in a television. Also for example, the method 200 (or a portion thereof) may be performed in a television receiver (e.g., a stand-alone cable and/or satellite television receiver (or set top box), a digital video recorder with television receiver capability, a gaming device with television receiver capability, etc.). Additionally for example, the method 200 (or a portion thereof) may be performed in a television controller (e.g., a dedicated television or entertainment system remote control, a personal electronic device with television control capability, etc.). Further for example, the method 200 may be performed in any combination of the user's local television system components. For example, in a non-limiting exemplary scenario, one or more modules of a television may operate to perform at least steps 220 and 225, one or more modules of a television controller may operate to perform at least step 230, and one or more modules of a television receiver may operate to perform at least step 240. Additionally, various portions of any of the above-mentioned method steps (e.g., step 220, 225, 230 and 240) may be performed in any one or more components (or devices) remote from the user's local television system.

Additionally, the steps of the exemplary method 200 (or aspects thereof) may, for example, be performed in real-time. In such manner, the user may have relatively expeditious access to functionality associated with the user-selected action. Alternatively for example, the exemplary method 200 (or aspects thereof) may be performed off-line in a manner in which functionality associated with the user-selected action is provided to the user at a later time (e.g., after presentation of the television program, upon the user logging into the user's computer system, upon the user accessing email, etc.).

Further, any or all of the steps of the exemplary method 200 may be performed for user selection of an action related to an object in television programming as the programming is broadcast in real-time and/or may be performed for user selection of an action related to an object in television programming that has been recorded on a user (or home) television programming recorder (e.g., a personal video recorder (PVR), video cassette recorder (VCR), etc.) and is currently being presented to the user in a time-shifted manner. For example, a user may record a broadcast television program on a PVR for later viewing, view such recorded programming at a later time, and while viewing such time-shifted television programming at a later time, select user-selectable actions related to objects in such programming.

Similarly, any or all of the steps of the exemplary method 200 may be performed for user selection of an object in television programming that has been provided to the user (or stored by the user) on a physical storage medium (e.g., on a digital versatile disc (DVD), video cassette recorder tape, non-volatile memory device, etc.). For example, a user may purchase a set of DVDs including all episodes of a season of a television series, view each of such episodes at the convenience of the user, and while viewing such episodes, select user-selectable actions related to objects in such programming. Such DVDs may, for example, comprise any or all of the above-mentioned information (e.g., memory and/or network addressing for entities remote from the user's local television system, general information corresponding to user-selectable objects and/or related actions (or associated consumer goods and/or services), user interface information corresponding to user-selectable objects and/or related actions, executable software corresponding to user-selectable objects and/or related actions, etc.).

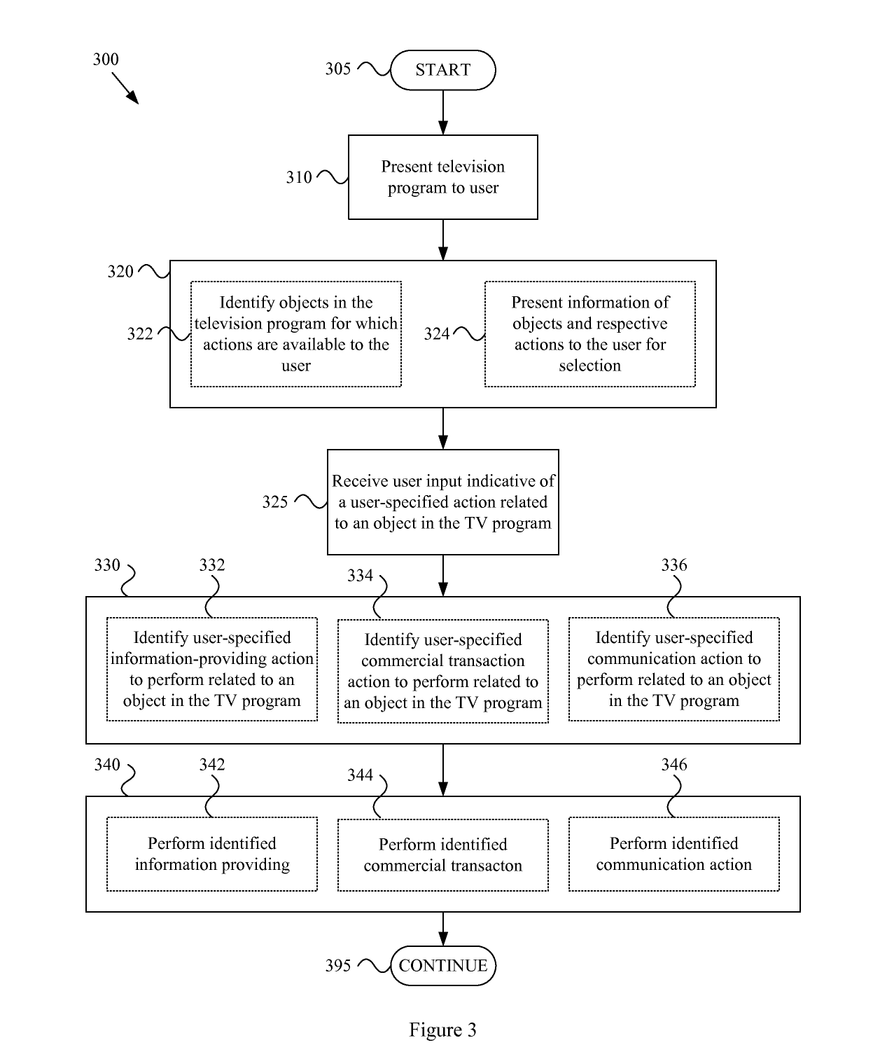

Turning next to FIG. 3, such figure is a flow diagram illustrating an exemplary method 300 for providing user-interaction related to an in-progress television program, in accordance with various aspects of the present invention. The exemplary method 300 may share any or all characteristics with the exemplary method 200 illustrated in FIG. 2 and discussed previously.

As with the exemplary method 200 discussed above, any or all aspects of the exemplary method 300 may, for example, be implemented in one or more devices of the user's local television system (e.g., any or all or the first television 140 and/or second television 141, the television receiver 151, the first television controller 160 and/or second television controller 161, etc., shown in FIG. 1 and discussed previously). Also, as with the exemplary method 200 discussed above, various aspects may also be performed in one or more system entities remote from the user's local television system.

The exemplary method 300 may, for example, begin executing at step 305. The exemplary method 300 may begin executing in response to any of a variety of causes or conditions. Step 305 may, for example, share any or all characteristics with step 205 of the exemplary method 200 illustrated in FIG. 2 and discussed previously.

The exemplary method 300 may, for example at step 310, comprise presenting a television program to a user, where the television program comprises objects in the program, such objects associated with respective actions selectable by a user. Step 310 may comprise presenting such television program to a user in any of a variety of manners, non-limiting examples of which will now be provided.

For example, step 310 may comprise receiving television programming. Many non-limiting examples of such television programming were provided above. Step 310 may comprise receiving the television programming from any of a variety of sources. For example and without limitation, step 310 may comprise receiving the television programming from a television broadcasting company, from a movie streaming company, from a user (or consumer) video recording and/or playback device (e.g., internal and/or external to the television), from an Internet television programming provider, from a gaming device comprising television program capability, from a DVD player, etc.

Step 310 may also comprise receiving the television programming via any of a variety of types of communication networks. Such networks may, for example, comprise a wireless television network (e.g., terrestrial and/or satellite) and/or cable television network. Such networks may, for example, comprise any of variety of general data communication networks (e.g., the Internet, a local area network, a personal area network, a metropolitan area network, etc.).

Step 310 may also, for example, comprise presenting received television programming to a user. Step 310 may, for example, comprise presenting television programming received (e.g., received from a local and/or non-local television program source) to a user in any of a variety of manners. For example, step 310 may comprise presenting the television programming on one or more of a screen of a television, television controller comprising a screen, television receiver comprising a screen, personal computer system, handheld computer, etc.

The presented television programming may, for example, comprise user-selectable objects (e.g., objects associated with consumer goods and/or services), and user-selectable actions associated with such objects. Many non-limiting examples of such user-selectable objects and/or associated actions were presented above.

In general, step 310 may comprise presenting a television program to a user, where the program comprises user-selectable objects (e.g., objects associated with consumer goods and/or services) with corresponding user-selectable actions in the program. Accordingly, the scope of various aspects of the present invention should not be limited by characteristics of any particular manner of receiving and/or presenting such a television program to a user unless explicitly claimed.

The exemplary method 300 may, at step 320, comprise providing a user interface by which a user may indicate an action to perform related to an object in the presented television program. Such object in the presented television program may, for example, correspond to a consumer good and/or service. Such action may, for example and without limitation, correspond to an information obtaining and/or providing action, a commercial transaction-related action, a communication session-related action, etc. Step 320 may share any or all characteristics with step 220 of the exemplary method 200 shown in FIG. 2 and discussed previously.

For example and without limitation, step 320 may comprise (e.g., at sub-step 322) identifying objects in the television program for which actions are available to the user. For example, even a single frame of a television program may comprise a large number of objects, of which only a portion have corresponding actions available to a user. Also for example, step 320 may comprise (e.g., at sub-step 324) presenting information of the identified objects and their respective actions to the user for selection by the user.

The exemplary method 300 may, for example at step 325, comprise receiving (e.g., using the user interface provided at step 320), a user input indicative of a user-specified action to perform related to an object in the presented television program. Step 325 may share any or all characteristics with step 225 of the exemplary method 200 shown in FIG. 2 and discussed previously.

The exemplary method 300 may, at step 330, comprise identifying (e.g., based at least in part on the user input received at step 325) an action to perform related to an object in the television program. Step 330 may, for example, share any or all characteristics with step 230 of the exemplary method 200 illustrated in FIG. 2 and discussed previously.

For example and without limitation, step 330 may (e.g., at sub-step 332) comprise identifying a user-specified information-providing action to perform related to an object in the presented television program. Also for example, step 330 may (e.g., at sub-step 334) comprise identifying a user-specified commercial transaction-related action to perform related to an object in the presented television program. Additionally for example, step 330 may (e.g., at sub-step 336) comprise identifying a user-specified communication action to perform related to an object in the presented television program.

The exemplary method 300 may, at step 340, comprise performing the one or more actions determined at step 330. Step 340 may, for example, share any or all characteristics with step 240 of the exemplary method 200 illustrated in FIG. 2 and discussed previously.

For example and without limitation, step 340 may (e.g., at sub-step 342) comprise performing an identified information-providing action. Also for example, step 340 may (e.g., at sub-step 344) comprise performing an identified commercial transaction. Additionally for example, step 340 may (e.g., at sub-step 346) comprise performing an identified communication action.

The exemplary method 300 may, for example at step 395, comprise performing continued operations. Step 395 may, for example, share any or all characteristics with step 295 of the exemplary method 200 illustrated in FIG. 2 and discussed previously.

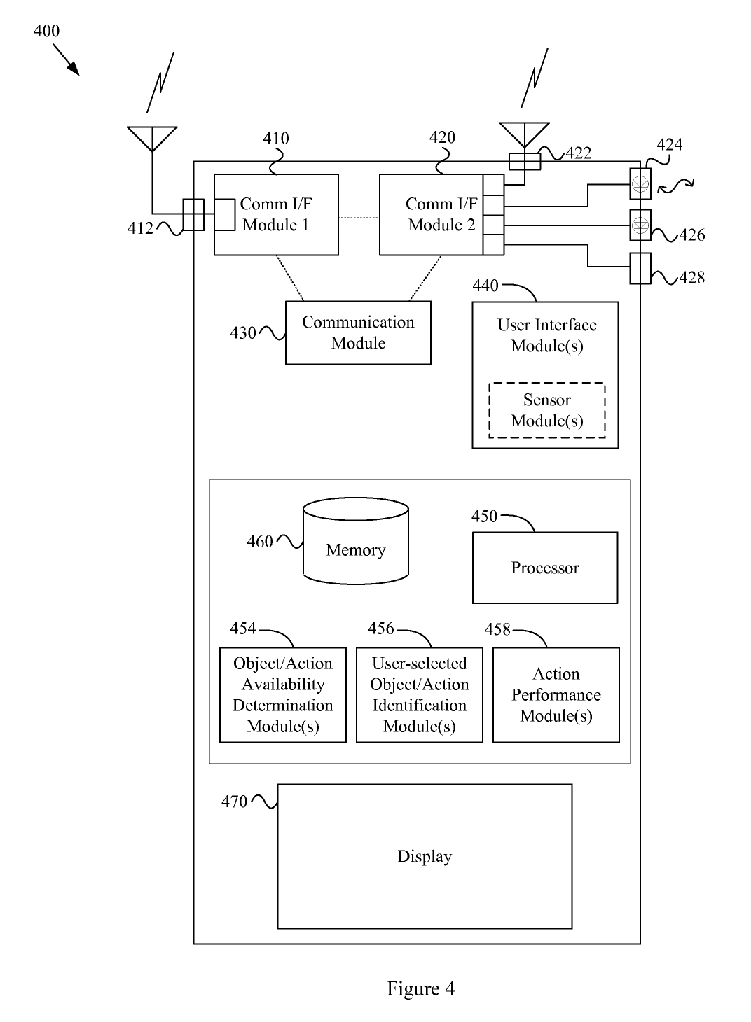

As discussed previously, any or all portion of the exemplary methods 200 and 300 may be implemented in one or more components (or devices) of a user's local television system. Various non-limiting examples of such implementation will now be presented in the discussion of FIGS. 4-7. Note that, as discussed previously, at least portions of the previously-discussed steps may also be performed in components remote from the user's local television system. In such an implementation, any or all of the components illustrated in FIGS. 4-7 may be utilized in such remote components to implement corresponding aspects of the present invention. Accordingly, the scope of various aspects of the present invention should not be limited by the following focus on various entities of the user's local television system unless explicitly claimed.

Turning next to FIG. 4, such figure is a diagram illustrating an exemplary television 400, in accordance with various aspects of the present invention. The exemplary television 400 may, for example, share any or all characteristics with one or more of the exemplary televisions 140 and 141 illustrated in FIG. 1 and discussed previously. Also, the exemplary television 400 (e.g., various modules thereof) may operate to perform any or all of the functionality discussed previously with regard to the exemplary methods 200 and 300 illustrated in FIGS. 2-3 and discussed previously.

The exemplary television 400 includes a first communication interface module 410. The first communication interface module 410 may, for example, operate to communicate over any of a variety of communication media and utilizing any of a variety of communication protocols. For example, though the first communication interface module 410 is illustrated coupled to a wireless RF antenna via a wireless port 412, the wireless medium is merely illustrative and non-limiting. The first communication interface module 410 may, for example, operate to communicate with one or more communication networks (e.g., cable television networks, satellite television networks, telecommunication networks, the Internet, local area networks, personal area networks, metropolitan area networks, etc.) via which television video content (e.g., television programming) and/or other data (e.g., commerce information) is communicated. Also for example, the first communication interface module 410 may operate to communicate with local sources of television video content (e.g., video recorders, receivers, gaming devices, etc.). Additionally, for example, the first communication interface module 410 may operate to communicate with a television controller and/or a television receiver external to the television 400 (e.g., directly or via one or more intermediate communication networks).

The exemplary television 400 includes a second communication interface module 420. The second communication interface module 420 may, for example, operate to communicate over any of a variety of communication media and utilizing any of a variety of communication protocols. For example, the second communication interface module 420 may communicate via a wireless RF communication port 422 and antenna, or may communicate via a non-tethered optical communication port 424 (e.g., utilizing laser diodes, photodiodes, etc.). Also for example, the second communication interface module 420 may communicate via a tethered optical communication port 426 (e.g., utilizing a fiber optic cable), or may communicate via a wired communication port 428 (e.g., utilizing coaxial cable, twisted pair, HDMI cable, Ethernet cable, any of a variety of wired component and/or composite video connections, etc.). The second communication interface module 420 may, for example, operate to communicate with one or more communication networks (e.g., cable television networks, satellite television networks, telecommunication networks, the Internet, local area networks, personal area networks, metropolitan area networks, etc.) via which television video content (e.g., television programming) and/or other data is communicated. Also for example, the second communication module 420 may operate to communicate with local sources of television video content (e.g., video recorders, receivers, gaming devices, etc.). Additionally, for example, the second communication module 420 may operate to communicate with a television controller (e.g., directly or via one or more intervening communication networks).

The exemplary television 400 may also comprise additional communication interface modules, which are not illustrated. Such additional communication interface modules may, for example, share any or all aspects with the first 410 and second 420 communication interface modules discussed above.

The exemplary television 400 may also comprise a communication module 430. The communication module 430 may, for example, operate to control and/or coordinate operation of the first communication interface module 410 and the second communication interface module 420 (and/or additional communication interface modules as needed). The communication module 430 may, for example, provide a convenient communication interface by which other components of the television 400 may utilize the first 410 and second 420 communication interface modules. Additionally, for example, in an exemplary scenario where a plurality of communication interface modules are sharing a medium and/or network, the communication module 430 may coordinate communications to reduce collisions and/or other interference between the communication interface modules.

The exemplary television 400 may additionally comprise one or more user interface modules 440. The user interface module(s) 440 may generally operate to provide user interface functionality to a user of the television 400. For example, and without limitation, the user interface module(s) 440 may operate to provide for user control of any or all standard television commands (e.g., channel control, volume control, on/off, screen settings, input selection, etc.). The user interface module(s) 440 may, for example, operate and/or respond to user commands utilizing user interface features disposed on the television (e.g., buttons, etc.) and may also utilize the communication module 430 (and/or first 410 and second 420 communication interface modules) to communicate with a television controller (e.g., a dedicated television remote control, a universal remote control, a cellular telephone, personal computing device, gaming controller, etc.).

The user interface module(s) 440 may also comprise one or more sensor modules that operate to interface with and/or control operation of any of a variety of sensors that may be utilized to ascertain an on-screen location. Such location may, for example, be utilized in determining a user-selected action.

Additionally, the user interface module(s) 440 may perform any of a variety of video output functions (e.g., presenting television programming to a user, providing visual feedback to a user regarding an identified user-selected object in the presented television programming, etc.). The user interface module(s) 440 may, for example, operate to perform any or all of the user interface functionality discussed herein (e.g., with regard to the method 200 (e.g., steps 220, 225, etc.) illustrated in FIG. 2, with regard to the method 300 illustrated in FIG. 3 (e.g., steps 320, 325, etc.), etc.).

The exemplary television 400 may comprise one or more processors 450. The processor(s) 450 may, for example, comprise a general purpose processor, digital signal processor, application-specific processor, microcontroller, microprocessor, etc. For example, the processor 450 may operate in accordance with software (or firmware) instructions. As mentioned previously, any or all functionality discussed herein may be performed (in-part or in-whole) by a processor executing instructions. For example, though various modules are illustrated as separate blocks or modules in FIG. 4, such illustrative modules, or a portion thereof, may be implemented by the processor 450.

The exemplary television 400 may comprise one or more memories 460. As discussed above, various aspects may be performed by one or more processors executing instructions. Such instructions may, for example, be stored in the one or more memories 460. Such memory 460 may, for example, comprise characteristics of any of a variety of types of memory. For example and without limitation, such memory 460 may comprise one or more memory chips (e.g., ROM, RAM, EPROM, EEPROM, flash memory, one-time-programmable OTP memory, etc.), hard drive memory, CD memory, DVD memory, etc.

Also as discussed previously, various information corresponding to user-selectable objects (e.g., objects associated with consumer goods and/or services, people, etc.) in television programming (e.g., descriptive information describing consumer goods and/or services, people, groups, places, communication information, information regarding obtaining consumer goods and/or services, user interaction information, user control information, information describing interactions with local and/or remote devices and associated with user-selectable objects and related consumer goods and/or services, information of user-selectable actions related to objects in television programming, communication session destination information, network addressing information, etc.) may be stored in memory. The memory 460 provides one non-limiting example of a memory in which such information may be stored. Note that such memory 460 (or a portion thereof) may also be external to the television 400 and communicatively coupled thereto.

The exemplary television 400 may comprise one or more modules (not explicitly illustrated in FIG. 4) that operate to receive and present a television program to a user. Such one or more modules may, for example, operate to utilize one or more of the user interface module(s) 440 to present the television program on the display 470. The one or more modules may, for example, operate to perform step 310 of the exemplary method 300 discussed previously.

The exemplary television 400 may comprise one or more user-selectable object and/or user-selectable action availability determination modules 454 that operate to determine the availability of user-selectable actions related to objects in a television program being presented to a user. For example, such module(s) 454 may operate to perform at least a portion of step 220 of the exemplary method 200 discussed previously and/or at least a portion of step 320 (e.g., sub-step 322) of the exemplary method 300 discussed previously.

For example, in an exemplary scenario in which the television 400 locally determines the identity of user-selectable actions related to objects in a television program, the module(s) 454 may operate to perform such functionality (e.g., by analyzing information received with the television program). Information of such identified user-selectable actions may then be presented to a user for selection (e.g., by the user interface module(s) 440). Additionally, for example, the module(s) 454 may operate to utilize the communication module 430 (and communication interface modules 410 and 420) to communicate with external systems regarding user selectable actions related to objects in television programming.

Also for example, in another exemplary scenario in which the television 400 operates to receive information of the identity of user-selectable actions related to objects in a television program from a source external to the television 400, the module(s) 454 may operate to utilize the communication module 430 (and communication interface modules 410 and 420) to communicate with such external source.

The exemplary television 400 may also, for example, comprise one or more user-selected object and/or action identification module(s) 456 that operate to identify (e.g., based at least in part on user input information received via the user interface module(s) 440) one or more actions in which to engage with an entity local to and/or remote from the user's local television system, where such action(s) are related to an object in a television program. For example, such module(s) 456 may operate to perform step 230 of the exemplary method 200 discussed previously and/or step 330 of the exemplary method 300 discussed previously.

For example, in a non-limiting exemplary scenario in which such action identification comprises analyzing a table or other data structure mapping (or linking) object and/or action identification to particular user inputs, the module(s) 456 may operate to analyze such a table and/or other data structure stored in the memory 460. Additionally for example, in an exemplary scenario in which such action identification comprises interacting with the user to further specify an action to perform related to an object in a television program, the module(s) 456 may operate to utilize the user interface module(s) 440 to perform such user interaction.

The exemplary television 400 may additionally comprise one or more action performance modules 458 that operate to perform the one or more actions determined by the action identification module(s) 456. For example, the action performance module(s) 458 may operate to perform step 240 of the exemplary method 200 discussed previously and/or step 340 of the exemplary method 300 discussed previously.

For example, in a non-limiting exemplary scenario in which an identified action comprises retrieving information associated with an object in a television program from a memory of an entity remote from the user's local television system (e.g., a memory of a commercial entity related to a particular consumer good and/or service), the module(s) 458 may operate to communicate with such memory (e.g., either directly, for example, utilizing DMA and/or indirectly utilizing an interface of the remote entity) of the remote entity. For example, the module(s) 458 may operate to utilize the communication module 430 (and first communication interface module 410 and/or second communication interface module 420) to communicate with such remote entity. Such a remote entity may, for example, comprise a communication infrastructure component of a television system, a television server component, a cable and/or satellite head-end station, a networked information server, a remote computer communicatively coupled to the television, a web-server or database of a commercial enterprise, etc.

Also for example, in a non-limiting scenario in which an identified action comprises searching for information associated with an object in a television program, the module(s) 458 may operate to perform a search for such information. In such a scenario, the module(s) 458 may, for example, operate to perform such a search in memory of other television system components and/or other networked entities (e.g., web-servers or databases of commercial enterprises) that are remote from the user's local television system (e.g., directly utilizing direct memory access and/or utilizing a search interface provided by a remote entity). For example, the module(s) 458 may operate to perform such a search in such remote entities utilizing the communication module 430 (and first communication interface module 410 and/or second communication interface module 420) to communicate with such remote entities. For example, such remote entities may provide an interface specifically adapted to request and/or search for information stored in and/or accessible to such remote entities. In such a scenario, the module(s) 458 may operate in accordance with such interface.

In an exemplary scenario, a remote entity may operate in accordance with a protocol in which a requestor requests (via a communication network) information (e.g., commerce information) associated with a particular user-selected object (or associated consumer good and/or service, associated person, etc.), and the remote entity responds to such a request by communicating the requested information back to the requestor. In such a scenario, the module(s) 458 would operate in accordance with such protocol when interacting with the remote entity via the communication network.

Additionally for example, in a non-limiting scenario in which an identified action comprises further interfacing with a user of the television 400, the module(s) 458 may operate to utilize the user interface module(s) 440 to provide the user interface.

For example, in an exemplary scenario in which an identified action comprises presenting object information (e.g., commerce information for a consumer good and/or service) and/or different views of the object to a user, the module(s) 458 may operate to utilize the user interface module(s) 440 to perform such output (e.g., on the display 470 of the television 400). Also for example, the module(s) 458 may operate to utilize the communication module 430 (and first communication interface module 410 and/or second communication interface module 420) to communicate with one or more other local television system components to provide such information to such one or more other local television system components for presentation on respective output displays of such one or more other local television system components.

Further for example, in a non-limiting scenario in which an identified action comprises establishing and/or managing a communication session between the user and another system entity (e.g., a television system and/or non-television system entity remote from the user's local television system), the module(s) 458 may operate to utilize the user interface module(s) 440 to provide the user interface and utilize the communication module(s) 430 (and first communication interface module 410 and/or second communication interface module 420) to communicate to perform communication link establishment and/or management. Such a communication session may, for example, be a communication session related to information obtaining, performing a commercial transaction, correspondence between people, etc.

Still further for example, in a non-limiting scenario in which a determined action comprises notifying one or more other television system and/or other networked entities of the user's selection of a particular action related to an object in a television program (e.g., a production enterprise, a distribution enterprise, a rating company, an advertising agency, etc.), the module(s) 458 may operate to utilize the communication module(s) 430 (and first communication interface module 410 and/or second communication interface module 420) to perform such notification.

Though not illustrated, the exemplary television 400 may, for example, comprise one or more modules that operate to perform any or all of the continued processing discussed previously with regard to step 295 of the exemplary method 200 and step 395 of the exemplary method 300, discussed previously. Such modules (e.g., as with the one or more modules 454, 456 and 458) may be performed by the processor(s) 450 executing instructions stored in the memory 460.

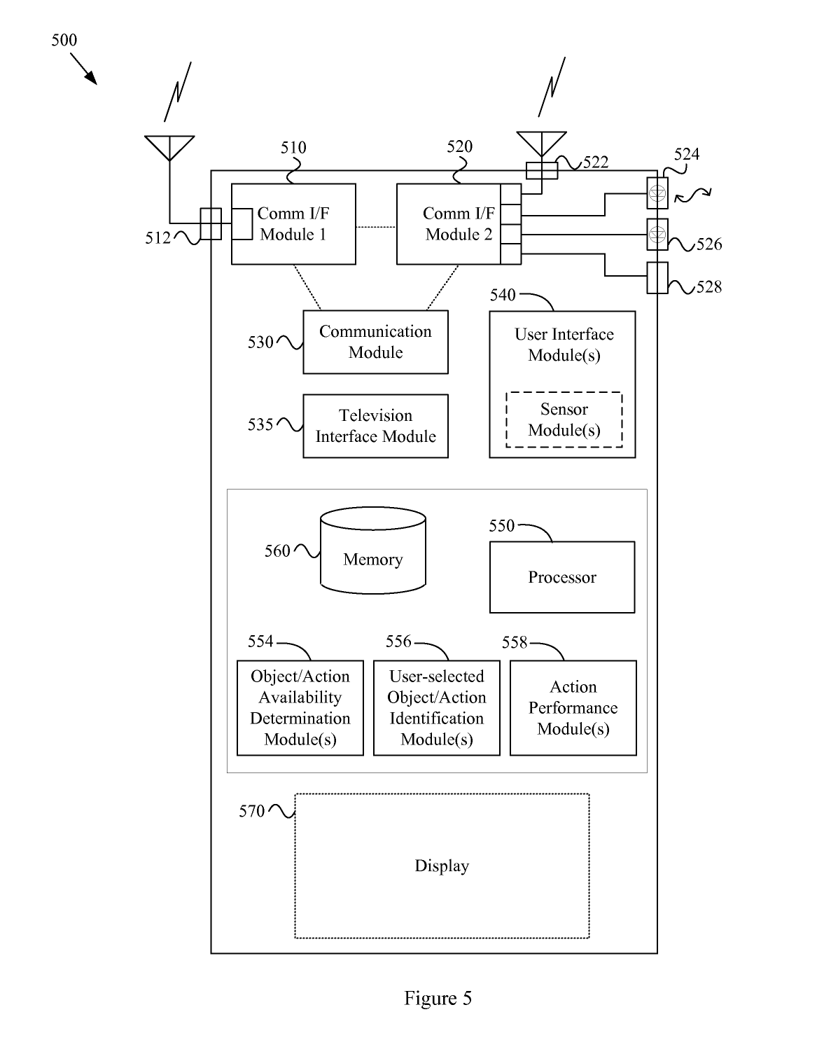

Turning next to FIG. 5, such figure is a diagram illustrating an exemplary television receiver 500, in accordance with various aspects of the present invention. The exemplary television receiver 500 may, for example, share any or all characteristics with the exemplary television receiver 151 illustrated in FIG. 1 and discussed previously. Also, the exemplary television receiver 500 may, for example, share any or all characteristics with the exemplary television 400 illustrated in FIG. 4 and discussed previously. For example, the exemplary television receiver 500 (e.g., various modules thereof) may operate to perform any or all of the functionality discussed previously with regard to the exemplary methods 200 and 300 illustrated in FIGS. 2-3 and discussed previously.

The exemplary television receiver 500 includes a first communication interface module 510. The first communication interface module 510 may, for example, operate to communicate over any of a variety of communication media and utilizing any of a variety of communication protocols. For example, though the first communication interface module 510 is illustrated coupled to a wireless RF antenna via a wireless port 512, the wireless medium is merely illustrative and non-limiting. The first communication interface module 510 may, for example, operate to communicate with one or more communication networks (e.g., cable television networks, satellite television networks, telecommunication networks, the Internet, local area networks, personal area networks, metropolitan area networks, etc.) via which television video content (e.g., television programming) and/or other data (e.g., commerce information) is communicated. Also for example, the first communication interface module 510 may operate to communicate with local sources of television video content (e.g., video recorders, receivers, gaming devices, etc.). Additionally, for example, the first communication interface module 510 may operate to communicate with a television controller and/or a television (e.g., directly or via one or more intermediate communication networks).

The exemplary television receiver 500 includes a second communication interface module 520. The second communication interface module 520 may, for example, operate to communicate over any of a variety of communication media and utilizing any of a variety of communication protocols. For example, the second communication interface module 520 may communicate via a wireless RF communication port 522 and antenna, or may communicate via a non-tethered optical communication port 524 (e.g., utilizing laser diodes, photodiodes, etc.). Also for example, the second communication interface module 520 may communicate via a tethered optical communication port 526 (e.g., utilizing a fiber optic cable), or may communicate via a wired communication port 528 (e.g., utilizing coaxial cable, twisted pair, HDMI cable, Ethernet cable, any of a variety of wired component and/or composite video connections, etc.). The second communication interface module 520 may, for example, operate to communicate with one or more communication networks (e.g., cable television networks, satellite television networks, telecommunication networks, the Internet, local area networks, personal area networks, metropolitan area networks, etc.) via which television video content (e.g., television programming) and/or other data is communicated. Also for example, the second communication module 520 may operate to communicate with local sources of television video content (e.g., video recorders, receivers, gaming devices, etc.). Additionally, for example, the second communication module 520 may operate to communicate with a television controller and/or a television external to the television receiver 500 (e.g., directly or via one or more intervening communication networks). The second communication interface module 520 may, for example, operate to communicate video and/or graphics information to a television and/or television receiver (e.g., using any of the previous interfaces mentioned above).

The exemplary television receiver 500 may also comprise additional communication interface modules, which are not illustrated. Such additional communication interface modules may, for example, share any or all aspects with the first 510 and second 520 communication interface modules discussed above.

The exemplary television receiver 500 may also comprise a communication module 530. The communication module 530 may, for example, operate to control and/or coordinate operation of the first communication interface module 510 and the second communication interface module 520 (and/or additional communication interface modules as needed). The communication module 530 may, for example, provide a convenient communication interface by which other components of the television receiver 500 may utilize the first 510 and second 520 communication interface modules. Additionally, for example, in an exemplary scenario where a plurality of communication interface modules are sharing a medium and/or network, the communication module 530 may coordinate communications to reduce collisions and/or other interference between the communication interface modules.

The exemplary television receiver 500 may also comprise one or more television interface modules 535 that operate to provide an interface between the television receiver 500 and a television (e.g., a television external to the television receiver 500 or housed with the television receiver). For example, the television interface module(s) 535 may operate to provide video, graphical and/or textual information to a television (e.g., via the communication module 530, first communication interface module(s) 510 and/or second communication interface module(s) 520).

The exemplary television receiver 500 may additionally comprise one or more user interface modules 540. The user interface module(s) 540 may generally operate to provide user interface functionality to a user of the television receiver 500. For example, and without limitation, the user interface module(s) 540 may operate to provide for user control of any or all standard television commands (e.g., channel control, volume control, on/off, screen settings, input selection, etc.). The user interface module(s) 540 may, for example, operate and/or respond to user commands utilizing user interface features disposed on the television receiver 500 (e.g., buttons, etc.) and may also utilize the communication module 530 (and/or first 510 and second 520 communication interface modules) to communicate with a television controller (e.g., a dedicated television remote control, a universal remote control, a cellular telephone, personal computing device, gaming controller, etc.).

The user interface module(s) 540 may also comprise one or more sensor modules that operate to interface with and/or control operation of any of a variety of sensors that may be utilized to ascertain an on-screen location. Such location may, for example, be utilized in determining a user-selected action.

Additionally, the user interface module(s) 540 may perform any of a variety of video output functions (e.g., presenting television programming to a user, providing visual feedback to a user regarding an identified user-selected object in the presented television programming, etc.). The user interface module(s) 440 may, for example, operate to perform any or all of the user interface functionality discussed herein (e.g., with regard to the method 200 (e.g., steps 220, 225, etc.) illustrated in FIG. 2, with regard to the method 300 illustrated in FIG. 3 (e.g., steps 320, 325, etc.), etc.).

The exemplary television receiver 500 may comprise one or more processors 550. The processor(s) 550 may, for example, comprise a general purpose processor, digital signal processor, application-specific processor, microcontroller, microprocessor, etc. For example, the processor 550 may operate in accordance with software (or firmware) instructions. As mentioned previously, any or all functionality discussed herein may be performed by a processor executing instructions. For example, though various modules are illustrated as separate blocks or modules in FIG. 5, such illustrative modules, or a portion thereof, may be implemented by the processor 550.

The exemplary television receiver 500 may comprise one or more memories 560. As discussed above, various aspects may be performed by one or more processors executing instructions. Such instructions may, for example, be stored in the one or more memories 560. Such memory 560 may, for example, comprise characteristics of any of a variety of types of memory. For example and without limitation, such memory 560 may comprise one or more memory chips (e.g., ROM, RAM, EPROM, EEPROM, flash memory, one-time-programmable OTP memory, etc.), hard drive memory, CD memory, DVD memory, etc.

Also as discussed previously, various information corresponding to user-selectable objects (e.g., objects associated with consumer goods and/or services) in television programming (e.g., descriptive information describing consumer goods and/or services, people, groups, places, communication information, information regarding obtaining consumer goods and/or services, user interaction information, user control information, information describing interactions with local and/or remote entities and associated with user-selectable objects and related consumer goods and/or services, information of user-selectable actions related to objects in television programming, communication session destination information, network addressing information, etc.) may be stored in memory. The memory 560 provides one non-limiting example of a memory in which such information may be stored. Note that such memory 560 (or a portion thereof) may also be external to the television 500 and communicatively coupled thereto.

The exemplary television receiver 500 may comprise one or more modules (not explicitly illustrated in FIG. 5) that operate to receive and present a television program to a user. Such one or more modules may, for example, operate to utilize one or more of the user interface module(s) 540 to present the television program on the optional display 570 of the receiver 500 (if present) and/or a display communicatively coupled to the receiver 500. The one or more modules may, for example, operate to perform step 310 of the exemplary method 300 discussed previously.

The exemplary television receiver 500 may comprise one or more user-selectable object and/or user-selectable action availability determination modules 554 that operate to determine the availability of user-selectable actions related to objects in a television program being presented to a user. For example, such module(s) 554 may operate to perform at least a portion of step 220 of the exemplary method 200 discussed previously and/or at least a portion of step 320 (e.g., sub-step 322) of the exemplary method 300 discussed previously.

For example, in an exemplary scenario in which the television receiver 500 locally determines the identity of user-selectable actions related to objects in a television program, the module(s) 554 may operate to perform such functionality (e.g., by analyzing information received with the television program). Information of such identified user-selectable actions may then be presented to a user for selection (e.g., by the user interface module(s) 540). Additionally, for example, the module(s) 554 may operate to utilize the communication module 530 (and communication interface modules 510 and 520) to communicate with external systems regarding user selectable actions related to objects in television programming.

Also for example, in another exemplary scenario in which the television receiver 500 operates to receive information of the identity of user-selectable actions related to objects in a television program from a source external to the television receiver 500, the module(s) 554 may operate to utilize the communication module 530 (and communication interface modules 510 and 520) to communicate with such external source.

The exemplary television receiver 500 may also, for example, comprise one or more user-selected object and/or action identification module(s) 556 that operate to identify (e.g., based at least in part on user input information received via the user interface module(s) 540), one or more actions in which to engage with an entity local to and/or remote from the user's local television system, where such action(s) are related to an object in a television program. For example, such module(s) 556 may operate to perform step 230 of the exemplary method 200 discussed previously and/or step 330 of the exemplary method 300 discussed previously.

For example, in a non-limiting exemplary scenario in which such action identification comprises analyzing a table or other data structure mapping (or linking) object and/or action identification to particular user inputs, the module(s) 556 may operate to analyze such a table and/or other data structure stored in the memory 560. Additionally for example, in an exemplary scenario in which such action identification comprises interacting with the user to further specify an action to perform related to an object in a television program, the module(s) 556 may operate to utilize the user interface module(s) 540 to perform such user interaction.

The exemplary television receiver 500 may additionally comprise one or more action performance modules 558 that operate to perform the one or more interactions determined by the action identification module(s) 556. For example, the action performance module(s) 558 may operate to perform step 240 of the exemplary method 200 discussed previously and/or step 340 of the exemplary method 300 discussed previously.

For example, in a non-limiting exemplary scenario in which an identified action comprises retrieving information associated with an object in a television program from a memory of an entity remote from the user's local television system (e.g., a memory of a commercial entity related to a particular consumer good and/or service), the module(s) 558 may operate to communicate with such memory of the remote entity (e.g., either directly, for example, utilizing DMA and/or indirectly utilizing an interface of the remote entity). For example, the module(s) 558 may operate to utilize the communication module 530 (and first communication interface module 510 and/or second communication interface module 520) to communicate with such remote entity. Such a remote entity may, for example, comprise a communication infrastructure component of a television system, a television server component, a cable and/or satellite head-end station, a networked information server, a remote computer communicatively coupled to the television, a web-server or database of a commercial enterprise, etc.

Also for example, in a non-limiting scenario in which an identified action comprises searching for information associated with an object in a television program, the module(s) 558 may operate to perform a search for such information. In such a scenario, the module(s) 558 may, for example, operate to perform such a search in memory of other television system components and/or other networked entities (e.g., web-servers or databases of commercial enterprises) that are remote from the user's local television system (e.g., directly utilizing direct memory access and/or utilizing a search interface provided by a remote entity). For example, the module(s) 558 may operate to perform such a search in such remote entities utilizing the communication module 530 (and first communication interface module 510 and/or second communication interface module 520) to communicate with such remote entities. For example, such remote entities may provide an interface specifically adapted to request and/or search for information stored in and/or accessible to such remote entities. In such a scenario, the module(s) 558 may operate in accordance with such interface.

In an exemplary scenario, a remote entity may operate in accordance with a protocol in which a requestor requests (via a communication network) information (e.g., commerce information) associated with a particular user-selected object (or associated consumer good and/or service, associated person, etc.), and the remote entity responds to such a request by communicating the requested information back to the requestor. In such a scenario, the module(s) 558 would operate in accordance with such protocol when interacting with the remote entity via the communication network.

Additionally for example, in a non-limiting scenario in which an identified action comprises further interfacing with a user of the television receiver 500, the module(s) 558 may operate to utilize the user interface module(s) 540 to provide the user interface.

For example, in an exemplary scenario in which an identified action comprises presenting object information (e.g., commerce information for a consumer good and/or service) and/or different views of the object to a user, the module(s) 558 may operate to utilize the user interface module(s) 540 to perform such output (e.g., on the optional display 570 of the television receiver 500 if such a display 570 is included). Also for example, the module(s) 558 may operate to utilize the communication module 530 (and first communication interface module 510 and/or second communication interface module 520) to communicate with one or more other local television system components (e.g., a television, television controller, personal computing device or system, etc. coupled to the television receiver 500) to provide such information to such one or more other local television system components for presentation on respective output displays of such one or more other local television system components.

Further for example, in a non-limiting scenario in which an identified action comprises establishing and/or managing a communication session between the user and another system entity, the module(s) 558 may operate to utilize the user interface module(s) 540 to provide the user interface and utilize the communication module(s) 530 (and first communication interface module 510 and/or second communication interface module 520) to communicate to perform communication link establishment and/or management. Such a communication session may, for example, be a communication session related to information obtaining, performing a commercial transaction, correspondence between people, etc.

Still further for example, in a non-limiting scenario in which a determined action comprises notifying one or more other television system and/or other networked entities of the user's selection of a particular action related to an object in a television program (e.g., a production enterprise, a distribution enterprise, a rating company, an advertising agency, etc.), the module(s) 558 may operate to utilize the communication module(s) 530 (and first communication interface module 510 and/or second communication interface module 520) to perform such notification.

Though not illustrated, the exemplary television receiver 500 may, for example, comprise one or more modules that operate to perform any or all of the continued processing discussed previously with regard to step 295 of the exemplary method 200 and step 395 of the exemplary method 300, discussed previously. Such modules (e.g., as with the one or more modules 554, 556 and 558) may be performed by the processor(s) 550 executing instructions stored in the memory 560.

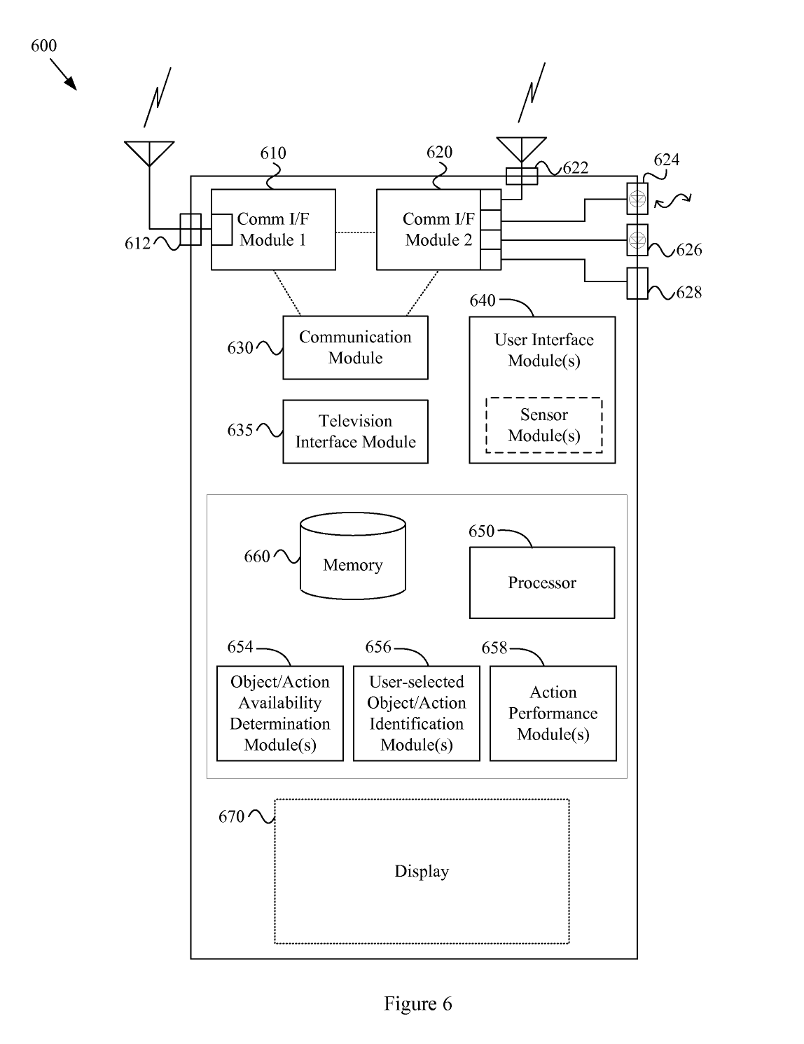

Turning next to FIG. 6, such figure is a diagram illustrating an exemplary television controller 600, in accordance with various aspects of the present invention. The exemplary television controller 600 may, for example, share any or all characteristics with the exemplary television controllers 160 and 161 illustrated in FIG. 1 and discussed previously. Also, the exemplary television controller 600 may, for example, share any or all characteristics with the exemplary television 400 illustrated in FIG. 4 and discussed previously and/or with the exemplary television receiver 500 illustrated in FIG. 5 and discussed previously. For example, the exemplary television controller 600 (e.g., various modules thereof) may operate to perform any or all of the functionality discussed previously with regard to the exemplary methods 200 and 300 illustrated in FIGS. 2-3 and discussed previously.

The exemplary television controller 600 includes a first communication interface module 610. The first communication interface module 610 may, for example, operate to communicate over any of a variety of communication media and utilizing any of a variety of communication protocols. For example, though the first communication interface module 610 is illustrated coupled to a wireless RF antenna via a wireless port 612, the wireless medium is merely illustrative and non-limiting. The first communication interface module 610 may, for example, operate to communicate with one or more communication networks (e.g., cable television networks, satellite television networks, telecommunication networks, the Internet, local area networks, personal area networks, metropolitan area networks, etc.) via which television video content (e.g., television programming) and/or other data (e.g., commerce information) is communicated. Also for example, the first communication interface module 610 may operate to communicate with local sources of television video content (e.g., video recorders, receivers, gaming devices, etc.). Additionally, for example, the first communication interface module 610 may operate to communicate with a television controller and/or a television (e.g., directly or via one or more intermediate communication networks).

The exemplary television controller 600 includes a second communication interface module 620. The second communication interface module 620 may, for example, operate to communicate over any of a variety of communication media and utilizing any of a variety of communication protocols. For example, the second communication interface module 520 may communicate via a wireless RF communication port 622 and antenna, or may communicate via a non-tethered optical communication port 624 (e.g., utilizing laser diodes, photodiodes, etc.). Also for example, the second communication interface module 620 may communicate via a tethered optical communication port 626 (e.g., utilizing a fiber optic cable), or may communicate via a wired communication port 628 (e.g., utilizing coaxial cable, twisted pair, HDMI cable, Ethernet cable, any of a variety of wired component and/or composite video connections, etc.). The second communication interface module 620 may, for example, operate to communicate with one or more communication networks (e.g., cable television networks, satellite television networks, telecommunication networks, the Internet, local area networks, personal area networks, metropolitan area networks, etc.) via which television video content (e.g., television programming) and/or other data is communicated. Also for example, the second communication module 620 may operate to communicate with local sources of television video content (e.g., video recorders, receivers, gaming devices, etc.). Additionally, for example, the second communication module 620 may operate to communicate with a television controller and/or a television external to the television controller 600 (e.g., directly or via one or more intervening communication networks). The second communication interface module 620 may, for example, operate to communicate video and/or graphics information to a television and/or television receiver (e.g., using any of the previous interfaces mentioned above).

The exemplary television controller 600 may also comprise additional communication interface modules, which are not illustrated. Such additional communication interface modules may, for example, share any or all aspects with the first 610 and second 620 communication interface modules discussed above.

The exemplary television controller 600 may also comprise a communication module 630. The communication module 630 may, for example, operate to control and/or coordinate operation of the first communication interface module 610 and the second communication interface module 620 (and/or additional communication interface modules as needed). The communication module 630 may, for example, provide a convenient communication interface by which other components of the television controller 600 may utilize the first 610 and second 620 communication interface modules. Additionally, for example, in an exemplary scenario where a plurality of communication interface modules are sharing a medium and/or network, the communication module 630 may coordinate communications to reduce collisions and/or other interference between the communication interface modules.

The exemplary television controller 600 may also comprise one or more television interface modules 635 that operate to provide an interface between the television controller 600 and a television (e.g., a television external to the television controller 600). For example, the television interface module(s) 635 may operate to provide video, graphical and/or textual information to a television and/or television receiver (e.g., via the communication module 630, first communication interface module(s) 610 and/or second communication interface module(s) 620).

The exemplary television controller 600 may additionally comprise one or more user interface modules 640. The user interface module(s) 640 may generally operate to provide user interface functionality to a user of the television controller 600. For example, and without limitation, the user interface module(s) 640 may operate to provide for user control of any or all standard television commands (e.g., channel control, volume control, on/off, screen settings, input selection, etc.). The user interface module(s) 640 may, for example, operate and/or respond to user commands utilizing user interface features disposed on the television controller 600 (e.g., buttons, etc.) and may also utilize the communication module 630 (and/or first 610 and second 620 communication interface modules) to communicate with a television and/or television receiver.

The user interface module(s) 640 may also comprise one or more sensor modules that operate to interface with and/or control operation of any of a variety of sensors that may be utilized to ascertain an on-screen location. Such location may, for example, be utilized in determining a user-selected action.

Additionally, the user interface module(s) 640 may perform any of a variety of video output functions (e.g., presenting television programming to a user, providing visual feedback to a user regarding an identified user-selected object in the presented television programming, etc.). The user interface module(s) 440 may, for example, operate to perform any or all of the user interface functionality discussed herein (e.g., with regard to the method 200 (e.g., steps 220, 225, etc.) illustrated in FIG. 2, with regard to the method 300 illustrated in FIG. 3 (e.g., steps 320, 325, etc.), etc.).

The exemplary television controller 600 may comprise one or more processors 650. The processor(s) 650 may, for example, comprise a general purpose processor, digital signal processor, application-specific processor, microcontroller, microprocessor, etc. For example, the processor 650 may operate in accordance with software (or firmware) instructions. As mentioned previously, any or all functionality discussed herein may be performed by a processor executing instructions. For example, though various modules are illustrated as separate blocks or modules in FIG. 6, such illustrative modules, or a portion thereof, may be implemented by the processor 650.

The exemplary television controller 600 may comprise one or more memories 660. As discussed above, various aspects may be performed by one or more processors executing instructions. Such instructions may, for example, be stored in the one or more memories 660. Such memory 660 may, for example, comprise characteristics of any of a variety of types of memory. For example and without limitation, such memory 660 may comprise one or more memory chips (e.g., ROM, RAM, EPROM, EEPROM, flash memory, one-time-programmable OTP memory, etc.), hard drive memory, CD memory, DVD memory, etc.

Also as discussed previously, various information corresponding to user-selectable objects (e.g., objects associated with consumer goods and/or services) in television programming (e.g., descriptive information describing consumer goods and/or services, people, groups, places, communication information, information regarding obtaining consumer goods and/or services, user interaction information, user control information, information describing interactions with local and/or remote entities and associated with user-selectable objects and related consumer goods and/or services, information of user-selectable actions related to objects in television programming, communication session destination information, network addressing information, etc.) may be stored in memory. The memory 660 provides one non-limiting example of a memory in which such information may be stored. Note that such memory 660 (or a portion thereof) may also be external to the television 600 and communicatively coupled thereto.

The exemplary television controller 600 may comprise one or more modules (not explicitly illustrated in FIG. 6) that operate to receive and present a television program to a user. Such one or more modules may, for example, operate to utilize one or more of the user interface module(s) 640 to present the television program on the optional display 670 (if present with the television controller 600 and/or communicatively coupled thereto). The one or more modules may, for example, operate to perform step 310 of the exemplary method 300 discussed previously.

The exemplary television controller 600 may comprise one or more user-selectable object and/or user-selectable action availability determination modules 654 that operate to determine the availability of user-selected actions related to objects in a television program being presented to a user. For example, such module(s) 654 may operate to perform at least a portion of step 220 of the exemplary method 200 discussed previously and/or at least a portion of step 320 (e.g., sub-step 322) of the exemplary method 300 discussed previously.

For example, in an exemplary scenario in which the television controller 600 locally determines the identity of user-selectable actions related to objects in a television program, the module(s) 654 may operate to perform such functionality (e.g., by analyzing information received with the television program). Information of such identified user-selectable actions may then be presented to a user for selection (e.g., by the user interface module(s) 640). Additionally, for example, the module(s) 654 may operate to utilize the communication module 630 (and communication interface modules 610 and 620) to communicate with external systems regarding user selectable actions related to objects in television programming.

Also for example, in another exemplary scenario in which the television controller 600 operates to receive information of the identity of user-selectable actions related to objects in a television program from a source external to the television controller 600, the module(s) 654 may operate to utilize the communication module 630 (and communication interface modules 610 and 620) to communicate with such external source.

The exemplary television controller 600 may also, for example, comprise one or more user-selected object and/or action identification module(s) 656 that operate to identify (e.g., based at least in part on user input information received via the user interface module(s) 640), one or more actions in which to engage with an entity local to and/or remote from the user's local television system, where such action(s) are related to an object in a television program. For example, such module(s) 656 may operate to perform step 230 of the exemplary method 200 discussed previously and/or step 330 of the exemplary method 300 discussed previously.

For example, in a non-limiting exemplary scenario in which such action identification comprises analyzing a table or other data structure mapping (or linking) object and/or action identification to particular user inputs, the module(s) 656 may operate to analyze such a table and/or other data structure stored in the memory 660. Additionally for example, in an exemplary scenario in which such action identification comprises interacting with the user to further specify an action to perform related to an object in a television program, the module(s) 656 may operate to utilize the user interface module(s) 640 to perform such user interaction.

The exemplary television controller 600 may additionally comprise one or more action performance modules 658 that operate to perform the one or more interactions determined by the action identification module(s) 656. For example, the action performance module(s) 658 may operate to perform step 240 of the exemplary method 200 discussed previously and/or step 340 of the exemplary method 300 discussed previously.

For example, in a non-limiting exemplary scenario in which an identified action comprises retrieving information associated with an object in a television program from memory of an entity remote from the user's local television system (e.g., a memory of a commercial entity related to a particular consumer good and/or service), the module(s) 658 may operate to communicate with such memory of the remote entity (e.g., either directly, for example, utilizing DMA and/or indirectly utilizing an interface of the remote entity). For example, the module(s) 658 may operate to utilize the communication module 630 (and first communication interface module 610 and/or second communication interface module 620) to communicate with such remote entity. Such a remote entity may, for example, comprise a communication infrastructure component of a television system, a television server component, a cable and/or satellite head-end station, a networked information server, a remote computer communicatively coupled to the television, a web-server or database of a commercial enterprise, etc.

Also for example, in a non-limiting scenario in which an identified action comprises searching for information associated with an object in a television program, the module(s) 658 may operate to perform a search for such information. In such a scenario, the module(s) 658 may, for example, operate to perform such a search in memory of other television system components and/or other networked entities (e.g., web-servers or databases of commercial enterprises) that are remote from the user's local television system (e.g., directly utilizing direct memory access and/or utilizing a search interface provided by a remote entity). For example, the module(s) 658 may operate to perform such a search in such remote entities utilizing the communication module 630 (and first communication interface module 610 and/or second communication interface module 620) to communicate with such remote entities. For example, such remote entities may provide an interface specifically adapted to request and/or search for information stored in and/or accessible to such remote entities. In such a scenario, the module(s) 658 may operate in accordance with such interface.

In an exemplary scenario, a remote entity may operate in accordance with a protocol in which a requestor requests (via a communication network) information (e.g., commerce information) associated with a particular user-selected object (or associated consumer good and/or service, associated person, etc.), and the remote entity responds to such a request by communicating the requested information back to the requestor. In such a scenario, the module(s) 658 would operate in accordance with such protocol when interacting with the remote entity via the communication network.

Additionally for example, in a non-limiting scenario in which an identified action comprises further interfacing with a user of the television controller 600, the module(s) 658 may operate to utilize the user interface module(s) 640 to provide the user interface.

For example, in an exemplary scenario in which an identified action comprises presenting object information (e.g., commerce information for a consumer good and/or service) and/or different views of the object to a user, the module(s) 658 may operate to utilize the user interface module(s) 640 to perform such output (e.g., on the optional display 670 of the television controller 600 if such a display 670 is included). Also for example, the module(s) 658 may operate to utilize the communication module 630 (and first communication interface module 610 and/or second communication interface module 620) to communicate with one or more other local television system components (e.g., a television, television receiver, personal computing device or system, etc. coupled to the television controller 600) to provide such information to such one or more other local television system components for presentation on respective output displays of such one or more other local television system components.

Further for example, in a non-limiting scenario in which an identified action comprises establishing and/or managing a communication session between the user and another system entity, the module(s) 658 may operate to utilize the user interface module(s) 640 to provide the user interface and utilize the communication module(s) 630 (and first communication interface module 610 and/or second communication interface module 620) to communicate to perform communication link establishment and/or management. Such a communication session may, for example, be a communication session related to information obtaining, performing a commercial transaction, correspondence between people, etc.

Still further for example, in a non-limiting scenario in which a determined action comprises notifying one or more other television system and/or other networked entities of the user's selection of a particular action related to an object in a television program (e.g., a production enterprise, a distribution enterprise, a rating company, an advertising agency, etc.), the module(s) 658 may operate to utilize the communication module(s) 630 (and first communication interface module 610 and/or second communication interface module 620) to perform such notification.

Though not illustrated, the exemplary television controller 600 may, for example, comprise one or more modules that operate to perform any or all of the continued processing discussed previously with regard to step 295 of the exemplary method 200 and step 395 of the exemplary method 300, discussed previously. Such modules (e.g., as with the one or more modules 654, 656 and 658) may be performed by the processor(s) 650 executing instructions stored in the memory 660.

Though the previous discussions of FIGS. 4-6 presented various exemplary modules of a television 400, television receiver 500 and television controller 600, as discussed previously, various aspects of the present invention may be performed in a distributed system (e.g., by a plurality of components of the user's local television system). Accordingly, the scope of various aspects of the present invention should not be limited to performance by a single television system component (or device) unless explicitly claimed.

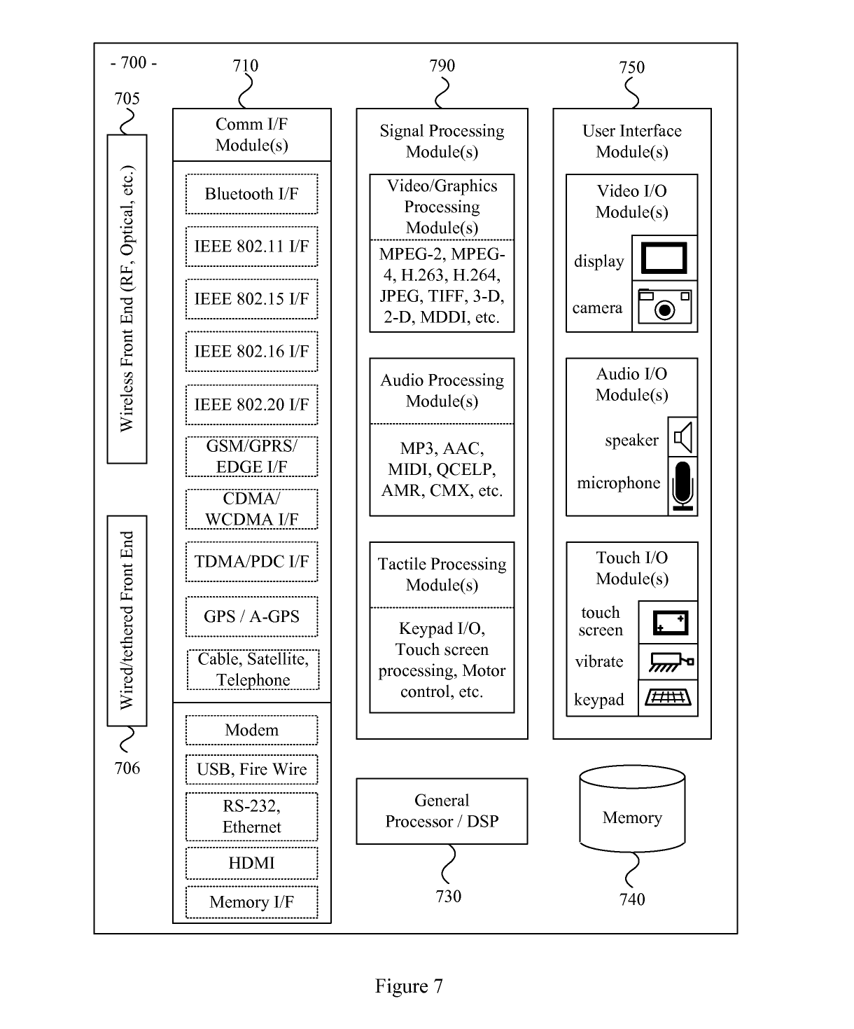

Turning next to FIG. 7, such figure is a diagram illustrating exemplary modules and/or sub-modules for a local television system, in accordance with various aspects of the present invention. The exemplary local television system 700 may share any or all aspects with any of the television 400, television receiver 500 and/or television controller 600 illustrated in FIGS. 4-6 and discussed above. The exemplary local television system 700 may, for example, share any or all characteristics with one or more of the exemplary televisions 140 and 141, television controllers 160 and 161, television receiver 151, television provider 110 and/or third party program information provider illustrated in FIG. 1 and discussed previously. Also, the exemplary local television system 700 (e.g., various modules thereof) may operate to perform any or all of the functionality discussed previously with regard to the exemplary methods 200 and 300 illustrated in FIGS. 2-3 and discussed previously. The components of the exemplary local television system 700 may be disposed in a single television system component (e.g., a single television, a single television receiver, a single television controller, etc.) or dispersed in a plurality of television system components (e.g., a plurality of components of a user's local television system, a combination of components comprising one or more components of the user's local television system and one or more components remote to the user's local television system, etc.).

For example, the local television system 700 comprises a processor 730. Such a processor 730 may, for example, share any or all characteristics with the processors 450, 550 and 650 discussed with regard to FIGS. 4-6. Also for example, the local television system 700 comprises a memory 740. Such memory 740 may, for example, share any or all characteristics with the memory 460, 560 and 660 discussed with regard to FIGS. 4-6.

Also for example, the local television system 700 may comprise any of a variety of user interface module(s) 750. Such user interface module(s) 750 may, for example, share any or all characteristics with the user interface module(s) 440, 540 and 640 discussed previously with regard to FIGS. 4-6. For example and without limitation, the user interface module(s) 750 may comprise: a display device, a camera (for still or moving picture acquisition), a speaker, an earphone (e.g., wired or wireless), a microphone, a video screen (e.g., a touch screen), a vibrating mechanism, a keypad, and/or any of a variety of other user interface devices (e.g., a mouse, a trackball, a touch pad, touch screen, light pen, game controlling device, etc.).

The exemplary local television system 700 may also, for example, comprise any of a variety of communication modules (705, 706, and 710). Such communication module(s) may, for example, share any or all characteristics with the communication interface module(s) 410, 420, 510, 520, 610 and 620 discussed previously with regard to FIGS. 4-6. For example and without limitation, the communication interface module(s) 710 may comprise: a Bluetooth interface module; an IEEE 802.11, 802.15, 802.16 and/or 802.20 module; any of a variety of cellular telecommunication interface modules (e.g., GSM/GPRS/EDGE, CDMA/CDMA2000/1x-EV-DO, WCDMA/HSDPA/HSUPA, TDMA/PDC, WiMAX, etc.); any of a variety of position-related communication interface modules (e.g., GPS, A-GPS, etc.); any of a variety of wired/tethered communication interface modules (e.g., USB, Fire Wire, RS-232, HDMI, Ethernet, wireline and/or cable modem, etc.); any of a variety of communication interface modules related to communicating with external memory devices; etc. The exemplary local television system 700 is also illustrated as comprising various wired 706 and/or wireless 705 front-end modules that may, for example, be included in the communication interface modules and/or utilized thereby.

The exemplary local television system 700 may also comprise any of a variety of signal processing module(s) 790. Such signal processing module(s) 790 may share any or all characteristics with modules of the exemplary television 400, television receiver 500 and/or television controller 600 that perform signal processing. Such signal processing module(s) 790 may, for example, be utilized to assist in processing various types of information discussed previously (e.g., with regard to sensor processing, position determination, video processing, image processing, audio processing, general user interface information data processing, etc.). For example and without limitation, the signal processing module(s) 790 may comprise: video/graphics processing modules (e.g. MPEG-2, MPEG-4, H.263, H.264, JPEG, TIFF, 3-D, 2-D, MDDI, etc.); audio processing modules (e.g., MP3, AAC, MIDI, QCELP, AMR, CMX, etc.); and/or tactile processing modules (e.g., Keypad I/O, touch screen processing, motor control, etc.).

In summary, various aspects of the present invention provide a system and method in a television system for providing user-interaction related to an in-progress television program. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for providing user interaction related to objects in a television program being presented, the method comprising:
in a television system:
providing a user interface by which a user may indicate an action to perform related to an object in the presented television program;
receiving, using the provided user interface, a user input indicative of a user-specified action to perform related to an object in the presented television program;
identifying, based at least in part on the received user input indicative of a user-specified action, an action to perform related to an object in the presented television program; and
performing the identified action.

2. The method of claim 1, wherein the action to perform related to an object in the presented television program comprises any one or more of:
presenting information to the user related to an object in the presented television program;
conducting a commercial transaction related to an object in the presented television program; and
initiating a communication with an entity related to an object in the presented television program.

3. The method of claim 1, wherein the object is an inanimate object.

4. The method of claim 1, wherein the object is one or both of a person and/or a group of people.

5. The method of claim 1, wherein the action to perform related to an object in the presented television program comprises presenting information specifically concerning the object presented in the television program.

6. The method of claim 1, wherein said providing a user interface by which a user may indicate an action to perform related to an object in the presented television program comprises providing for user-selection of the action to perform related to the object during only a portion of the presented television program.

7. The method of claim 6, wherein said providing for user-selection of the action to perform related to the object generally occurs only when the object appears in the presented television program.

8. The method of claim 6, wherein said providing for user-selection of the action to perform related to the object generally occurs only during a portion of the presented television program that is sponsored by a commercial enterprise associated with the object.

9. The method of claim 1, wherein the action to perform related to an object in the presented television program comprises performing a commercial transaction related to the object in the presented television program.

10. The method of claim 9, wherein said performing a commercial transaction related to the object in the presented television program comprises ordering a product associated with the object.

11. The method of claim 1, wherein the action to perform related to an object in the presented television program comprises establishing a communication session with a commercial enterprise associated with the object.

12. The method of claim 11, wherein said establishing a communication session with a commercial enterprise associated with the object comprises establishing a communication session with an Internet web site associated with the object.

13. The method of claim 1, wherein said providing a user interface by which a user may indicate an action to perform related to an object in the presented television program comprises presenting the user with a list of actions related to the object from which the user may select an action to perform.

14. The method of claim 13, wherein said presenting the user with a list of actions related to the object from which the user may select an action to perform comprises presenting the user with a plurality of nested lists of actions through which the user may navigate to select an action to perform.

15. The method of claim 13, wherein the presented list of actions comprises a list of entities with which a communication session may be established.

16. A system for providing user interaction related to objects in a television program being presented, the system comprising:
at least one module operable to, at least:
provide a user interface by which a user may indicate an action to perform related to an object in the presented television program;
receive, via the provided user interface, a user input indicative of a user-specified action to perform related to an object in the presented television program;
identify, based at least in part on the received user input indicative of a user-specified action, an action to perform related to an object in the presented television program; and
perform the identified action.

17. The system of claim 16, where the action to perform related to an object in the presented television program comprises any one or more of:
presenting information to the user related to an object in the presented television program;
conducting a commercial transaction related to an object in the presented television program; and
initiating a communication with an entity related to an object in the presented television program.

18. The system of claim 16, where the object is an inanimate object.

19. The system of claim 16, where the object is one or both of a person and/or a group of people.

20. The system of claim 16, where the action to perform related to an object in the presented television program comprises presenting information specifically concerning the object presented in the television program.

21. The system of claim 16, wherein said at least one module is operable to provide a user interface by which a user may indicate an action to perform related to an object in the presented television program by, at least in part, operating to provide for user-selection of the action to perform related to the object during only a portion of the presented television program.

22. The system of claim 21, wherein said at least one module operates to provide for user-selection of the action to perform related to the object generally only when the object appears in the presented television program.

23. The system of claim 21, wherein said at least one module operates to provide for user-selection of the action to perform related to the object generally only during a portion of the presented television program that is sponsored by a commercial enterprise associated with the object.

24. The system of claim 16, where the action to perform related to an object in the presented television program comprises performing a commercial transaction related to the object in the presented television program.

25. The system of claim 24, where performing a commercial transaction related to the object in the presented television program comprises ordering a product associated with the object.

26. The system of claim 16, where the action to perform related to an object in the presented television program comprises establishing a communication session with a commercial enterprise associated with the object

27. The system of claim 26, where said establishing a communication session with a commercial enterprise associated with the object comprises establishing a communication session with an Internet web site associated with the object.

28. The system of claim 16, wherein said at least one module is operable to provide a user interface by which a user may indicate an action to perform related to an object in the presented television program by, at least in part, operating to present the user with a list of actions related to the object from which the user may select an action to perform.

29. The system of claim 28, wherein said at least one module operates to present the user with a list of actions related to the object from which the user may select an action to perform by, at least in part, operating to present the user with a plurality of nested lists of actions through which the user may navigate to select an action to perform.

30. The system of claim 28, wherein the presented list of actions comprises a list of entities with which a communication session may be established.
